(19) United States
(12) Patent Application Publication
(10) Pub. No.: US 2019/0018818 A1
(43) Pub. Date: Jan. 17, 2019

(54) ACCELERATED I3C STOP INITIATED BY A THIRD PARTY

(71) Applicant: QUALCOMM Incorporated, San Diego, CA (US)

(72) Inventors: Sharon GRAIF, Zichron Yakov (IL); Radu PITIGOI-ARON, San Jose, CA (US); Lior AMARILIO, Yokneam (IL)

(21) Appl. No.: 16/008,509

(22) Filed: Jun. 14, 2018

Related U.S. Application Data
(60) Provisional application No. 62/532,530, filed on Jul. 14, 2017.

(51) Int. Cl. G06F 13/42; G06F 13/26; G06F 13/40; G06F 13/36

(52) U.S. Cl. CPC G06F 13/4291; G06F 13/26; G06F 2213/0038; G06F 13/36; G06F 2213/0016; G06F 13/4086

(57) ABSTRACT

Systems, methods, and apparatus for communication over a serial bus in accordance with an I3C protocol are described that enable a non-participating device to cause a master device on an I3C bus transmit a STOP condition that terminates a transaction with a slave device coupled to the I3C bus. A method performed at a master device coupled to a serial bus includes initiating a transaction between the master device and a first slave device, terminating the transaction before completion of the transaction when a second slave device intervenes in the transaction, and servicing the second slave device after terminating the transaction. The transaction may include transmissions of data frames over the serial bus. The second slave device may intervene when it is not a party to the transaction.

### TECHNICAL FIELD

This application claims priority to and the benefit of U.S. Provisional Patent Application Ser. No. 62/532,530 filed in the U.S. Patent Office on Jul. 14, 2017, the entire content of this application being incorporated herein by reference as if fully set forth below in its entirety and for all applicable purposes.

### TECHNICAL FIELD

The present disclosure relates generally to an interface between processors and peripheral devices and, more particularly, to improving control of a serial bus adapted to permit communication between devices.

### BACKGROUND

Certain devices, such as mobile communication devices, include a variety of components including circuit boards, integrated circuit (IC) devices and/or System-on-Chip (SoC) devices. The components may include processing circuits, user interface components, storage and other peripheral components that communicate through a serial bus. The serial bus may be operated in accordance with a standardized or proprietary protocol.

In one example, the Inter-Integrated Circuit serial bus, which may also be referred to as the I2C bus or the I²C bus, is a serial single-ended computer bus that was intended for use in connecting low-speed peripherals to a processor. In some examples, a serial bus may employ a multi-master protocol in which one or more devices can serve as a master and a slave for different messages transmitted on the serial bus. Data can be serialized and transmitted over two bidirectional wires, which may carry a data signal, which may be carried on a Serial Data Line (SDA), and a clock signal, which may be carried on a Serial Clock Line (SCL).

In another example, the protocols used on an I3C bus derives certain implementation aspects from the I2C protocol. The I3C bus are defined by the Mobile Industry Processor Interface Alliance (MIPI). Original implementations of I2C supported data signaling rates of up to 100 kilobits per second (100 kbps) in standard-mode operation, with more recent standards supporting speeds of 400 kbps in fast-mode operation, and 1 megabit per second (Mbps) in fast-mode plus operation. Certain protocols employed in I3C implementations can increase available bandwidth on the serial bus using higher transmitter clock rates, by encoding data in signaling state of two or more wires, and/or through other encoding techniques. Certain aspects of the I3C protocol are derived from corresponding aspects of the I2C protocol, and the I2C and I3C protocols can coexist on the same serial bus.

There is a continuous demand for increased performance of serial buses, and there exists an ongoing need for providing improved signaling and optimization of protocols used in I3C protocols and the like.

### SUMMARY

Certain aspects of the disclosure relate to systems, apparatus, methods and techniques that optimize throughput on a serial bus that may be operated in multiple modes of communication. In one example, techniques are disclosed in which a non-participating device causes a master device on an I3C bus transmit a STOP condition that terminates a transaction with a slave device coupled to the I3C bus.

In various aspects of the disclosure, a method performed at a master device coupled to a serial bus includes initiating a transaction between the master device and a first slave device, terminating the transaction before completion of the transaction when a second slave device intervenes in the transaction, and servicing the second slave device after terminating the transaction. The transaction may include transmissions of data frames over the serial bus. The second slave device may intervene when it is not a party to the transaction.

In one aspect, the second slave device intervenes in the transaction by transmitting in-band signaling on the serial bus while the transaction is being executed. The in-band signaling may include driving one or more wires of the serial bus when interface circuits of the master device and the first slave device are in a high-impedance mode of operation or an open-collector mode of operation between data frames of the transaction. Terminating the transaction before completion of the transaction may include transmitting a STOP condition on the serial bus. Terminating the transaction before completion of the transaction may include transmitting a repeated START condition followed by a STOP condition on the serial bus. Terminating the transaction before completion of the transaction may include continuing the in-band signaling to provide a repeated START condition on the serial bus, and transmitting a STOP condition on the serial bus.

In certain aspects, the master device may transmit a broadcast command on the serial bus, the broadcast command being configured to cause one or more slave devices to contend for access to the serial bus, and service the second slave device when the second slave device is identified as having highest priority of the one or more slave devices that are contending for access to the serial bus. The one or more slave devices may contend for access to the serial bus using in-band interrupts. The second slave device may be serviced when the second slave device is identified as having higher priority than one or more pending transactions to be executed by the master device. The second slave device may request termination of the transaction concurrently with an intervention by the second slave device in the transaction. The first device may be one of a plurality of slave devices concurrently contending for access to the serial bus. The master device may determine whether the second slave device is enabled to intervene in the transaction, and may service the second slave device when the second slave device is enabled to intervene in the transaction. The master device may identify a third slave device having higher priority data than data on the second slave device, determine that the second slave device is not enabled to intervene in the transaction, and service the second slave device when the second slave device is enabled to intervene in the transaction.

In one aspect, a configuration command may be transmitted to the second slave device.

The configuration command may be configured to enable the second slave device to intervene as an outsider in a transaction conducted on the serial bus.

In various aspects, an apparatus may be adapted to operate as a master device when coupled to a serial bus. The apparatus may include a bus interface circuit, and a processing device. The processing device may be adapted to initiate a transaction between the master device and a first slave device, terminate the transaction before completion of the transaction when a second slave device intervenes in the transaction, and service the second slave device after terminating the transaction. The transaction may include transmissions of data frames over the serial bus. The second slave device may not be a party to the transaction.

In certain aspects, the second slave device is configured to intervene in the transaction by transmitting in-band signaling on the serial bus while the transaction is being executed. The in-band signaling may include driving one or more wires of the serial bus when interface circuits of the master device and the first slave device are in a high-impedance mode of operation or an open-collector mode of operation between data frames of the transaction.

In some aspects, the apparatus is adapted to transmit a broadcast command on the serial bus. The broadcast command may be configured to cause one or more slave devices to contend for access to the serial bus. The apparatus may be adapted to service the second slave device when the second slave device is identified as having highest priority of the one or more slave devices that are contending for access to the serial bus. One or more slave devices may contend for access to the serial bus using in-band interrupts. The second slave device may be serviced when the second slave device is identified as having higher priority than one or more pending transactions to be executed by the master device.

In one aspect, the apparatus is adapted to transmit a configuration command to the second slave device. The configuration command may be configured to enable the second slave device to intervene as an outsider in a transaction conducted on the serial bus.

In various aspects, an apparatus includes means for initiating a transaction between the master device and a first slave device, means for terminating the transaction before completion of the transaction when a second slave device intervenes in the transaction, and means for servicing the second slave device after terminating the transaction. The transaction may include transmissions of data frames over the serial bus. The second slave device may otherwise be a non-participant in the transaction. The second slave device may intervene in the transaction by transmitting in-band signaling on the serial bus while the transaction is being executed. In-band signaling may include driving one or more wires of the serial bus when interface circuits of the master device and the first slave device are in a high-impedance mode of operation or an open-collector mode of operation between data frames of the transaction.

In one aspect, the means for servicing the second slave device may be adapted to transmit a broadcast command on the serial bus. The broadcast command may be configured to cause one or more slave devices to contend for access to the serial bus. The means for servicing the second slave device may be adapted to service the second slave device when the second slave device is identified as having highest priority of the one or more slave devices that are contending for access to the serial bus. The one or more slave devices contend for access to the serial bus using in-band interrupts. The second slave device may be serviced when the second slave device is identified as having higher priority than one or more pending transactions to be executed by the master device.

In various aspects, a processor-readable storage medium includes code, instructions, and/or data. The code, when executed by one or more processors may cause the one or more processors to initiate a transaction between the master device and a first slave device, terminate the transaction before completion of the transaction when a second slave device intervenes in the transaction, and service the second slave device after terminating the transaction. The transaction may include transmissions of data frames over the serial bus. The second slave device may not be a party to the transaction.

The second slave device may be configured to intervene in the transaction by transmitting in-band signaling on the serial bus while the transaction is being executed. In-band signaling may include driving one or more wires of the serial bus when interface circuits of the master device and the first slave device are in a high-impedance mode of operation or an open-collector mode of operation between data frames of the transaction.

### BRIEF DESCRIPTION OF THE DRAWINGS

FIG. 1 illustrates an apparatus employing a data link between IC devices that is selectively operated according to one of plurality of available standards.

FIG. 2 illustrates a system architecture for an apparatus employing a data link between IC devices.

FIG. 3 illustrates a configuration of devices coupled to a common serial bus.

FIG. 4 illustrates certain aspects of the timing relationship between SDA and SCL wires on a conventional I2C bus.

FIG. 5 is a timing diagram that illustrates timing associated with multiple frames transmitted on an I2C bus.

FIG. 6 illustrates timing related to a data word sent to a slave device in accordance with I3C protocols.

FIG. 7 illustrates an example of the timing associated with a data read from a slave device in accordance with I3C protocols.

FIG. 8 illustrates signaling on a serial bus when the serial bus is operated in a single data rate (SDR) mode of operation defined by I3C specifications.

FIG. 9 illustrates an example of a transmission in an I3C high data rate (HDR) mode, where data is transmitted at double data rate (DDR) on a serial bus.

FIG. 10 illustrates an example of a transmission in an I3C high data rate (HDR) mode, where data is transmitted in signaling state of a serial bus.

FIG. 11 illustrates an example of signaling transmitted on the SDA wire and SCL wire of a serial bus to initiate certain mode changes between SDR and HDR modes.

FIG. 12 illustrates a first example in which a bus master ends a read transaction early by emitting a repeated START condition, followed by a STOP condition in accordance with certain aspects disclosed herein.

FIG. 13 illustrates a second example in which a bus master ends a read transaction early by emitting a repeated START condition and continues with a different data transfer in accordance with certain aspects disclosed herein.

FIG. 14 illustrates a third example in which a bus master ends a read transaction early by emitting a repeated START condition, followed by a STOP condition in accordance with certain aspects disclosed herein.

FIG. 15 illustrates a fourth example in which a bus master ends a read transaction early by emitting a repeated START condition and continues with a different data transfer in accordance with certain aspects disclosed herein.

FIG. 16 illustrates a first example of an operation in which a master device forgoes an opportunity to transmit a repeated START condition in accordance with certain aspects disclosed herein.

FIG. 17 illustrates a second example of an operation in which a master device forgoes an opportunity to transmit a repeated START condition in accordance with certain aspects disclosed herein.

FIG. 18 illustrates a third example of an operation in which a master device forgoes an opportunity to transmit a repeated START condition in accordance with certain aspects disclosed herein.

FIG. 19 illustrates an example of a contention resolution process that may be executed by a master device adapted in accordance with certain aspects disclosed herein.

FIG. 20 is a block diagram illustrating an example of an apparatus employing a processing circuit that may be adapted according to certain aspects disclosed herein.

FIG. 21 is a flowchart illustrating certain operations of a slave device coupled to a serial bus and configured in accordance with certain aspects disclosed herein.

FIG. 22 illustrates an example of a hardware implementation for an apparatus adapted in accordance with certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the invention will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

Overview

Devices that include multiple SoCs and/or other IC devices often employ a serial bus to connect processors with modems and other peripherals. The serial bus may be operated in accordance with specifications and protocols defined by a standards body. In one example, the serial bus may be operated in accordance I3C protocols, which define timing relationships between signals and transmissions that enable devices limited to communicating in accordance with I2C protocols to coexist on a serial bus with devices that communicate in accordance with I3C protocols. According to various aspects of the disclosure, a device that is not a party to a transaction may intervene using in-band signaling to cause the master device to transmit a STOP condition and terminate the transaction early. The master device may perform a contention resolution process to determine whether multiple devices requested early termination of the transaction.

In some instances, the current master device may initiate an early termination, and may execute the contention process to determine if another device has concurrently intervened to initiate early termination. For example, the current master device may have one or more transactions pending that include high priority data, and the current master may initiate termination of a transaction in process at or near the time that a slave device, which is not party to the transaction, also initiates early termination. The current master device may participate in the contention procedure it initiates after early termination.

Example of an Apparatus with a Serial Data Link

According to certain aspects, a serial data link may be used to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similar functioning device.

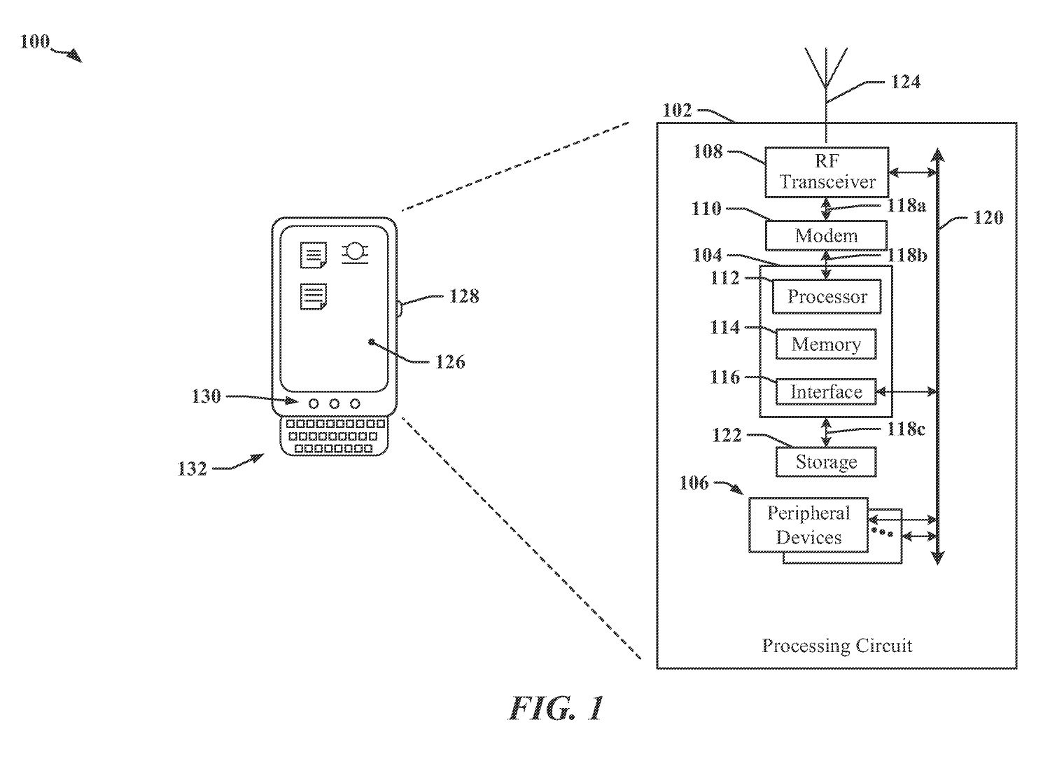

FIG. 1 illustrates an example of an apparatus 100 that may employ a data communication bus. The apparatus 100 may include a processing circuit 102 having multiple circuits or devices 104, 106, 108 and/or 110, which may be implemented in one or more ASICs and/or one or more SoCs. In one example, the apparatus 100 may be a communication device and the processing circuit 102 may include ASIC 104 that includes a processor 112. The ASIC 104 may implement or function as a host or application processor. The apparatus 100 may include one or more peripheral devices 106, one or more modems 110 and a transceiver 108 that enables the apparatus to communicate through an antenna 124 with a radio access network, a core access network, the Internet and/or another network. The configuration and location of the circuits or devices 104, 106, 108, 110 may vary between applications.

The circuits or devices 104, 106, 108, 110 may include a combination of sub-components. In one example, the ASIC 104 may include more than one processors 112, on-board memory 114, a bus interface circuit 116 and/or other logic circuits or functions. The processing circuit 102 may be controlled by an operating system that may provide an application programming interface (API) layer that enables the one or more processors 112 to execute software modules residing in the on-board memory 114 or other processor-readable storage 122 provided on the processing circuit 102. The software modules may include instructions and data stored in the on-board memory 114 or processor-readable storage 122. The ASIC 104 may access its on-board memory 114, the processor-readable storage 122, and/or storage external to the processing circuit 102. The on-board memory 114, the processor-readable storage 122 may include read-only memory (ROM) or random-access memory (RAM), electrically erasable programmable ROM (EEPROM), flash cards, or any memory device that can be used in processing systems and computing platforms. The processing circuit 102 may include, implement, or have access to a local database or other parameter storage that can maintain operational parameters and other information used to configure and operate the apparatus 100 and/or the processing circuit 102. The local database may be implemented using registers, a database module, flash memory, magnetic media, EEPROM, soft or hard disk, or the like. The processing circuit 102 may also be operably coupled to external devices such as the antenna 124, a display 126, operator controls, such as switches or buttons 128, 130 and/or an integrated or external keypad 132, among other components. A user interface module may be configured to operate with the display 126, keypad 132, etc. through a dedicated communication link or through one or more serial data interconnects.

The processing circuit 102 may provide one or more buses 118a, 118b, 118c, 120 that enable certain devices 104, 106, and/or 108 to communicate. In one example, the ASIC 104 may include a bus interface circuit 116 that includes a combination of circuits, counters, timers, control logic and other configurable circuits or modules. In one example, the bus interface circuit 116 may be configured to operate in accordance with communication specifications or protocols. The processing circuit 102 may include or control a power management function that configures and manages the operation of the apparatus 100.

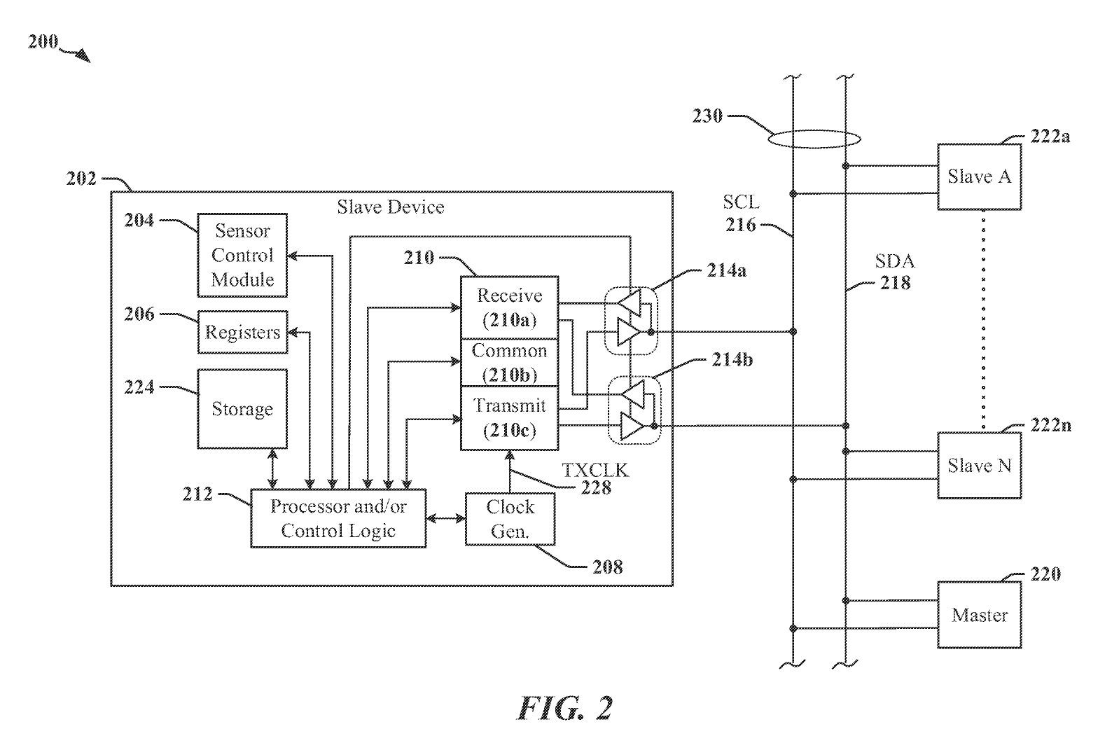

FIG. 2 illustrates certain aspects of an apparatus 200 that includes multiple devices 202, 220 and 222a-222n connected to a serial bus 230. The devices 202, 220 and 222a-222n may include one or more semiconductor IC devices, such as an applications processor, SoC or ASIC. Each of the devices 202, 220 and 222a-222n may include, support or operate as a modem, a signal processing device, a display driver, a camera, a user interface, a sensor, a sensor controller, a media player, a transceiver, and/or other such components or devices. Communications between devices 202, 220 and 222a-222n over the serial bus 230 is controlled by a bus master 220. Certain types of bus can support multiple bus masters 220.

The apparatus 200 may include multiple devices 202, 220 and 222a-222n that communicate when the serial bus 230 is operated in accordance with I2C, I3C or other protocols. At least one device 202, 222a-222n may be configured to operate as a slave device on the serial bus 230. In one example, a slave device 202 may be adapted to provide a sensor control function 204. The sensor control function 204 may include circuits and modules that support an image sensor, and/or circuits and modules that control and communicate with one or more sensors that measure environmental conditions. The slave device 202 may include configuration registers or other storage 206, control logic 212, a transceiver 210 and line drivers/receivers 214a and 214b. The control logic 212 may include a processing circuit such as a state machine, sequencer, signal processor or general-purpose processor. The transceiver 210 may include a receiver 210a, a transmitter 210c and common circuits 210b, including timing, logic and storage circuits and/or devices. In one example, the transmitter 210c encodes and transmits data based on timing provided by a clock generation circuit 208.

Two or more of the devices 202, 220 and/or 222a-222n may be adapted according to certain aspects and features disclosed herein to support a plurality of different communication protocols over a common bus, which may include the I2C protocol, and/or the I3C protocol. In some instances, devices that communicate using the I2C protocol can coexist on the same 2-wire interface with devices that communicate using I3C protocols. In one example, the I3C protocols may support a mode of operation that provides a data rate between 6 megabits per second (Mbps) and 16 Mbps with one or more optional high-data-rate (HDR) modes of operation that provide higher performance The I2C protocols may conform to de facto I2C standards providing for data rates that may range between 100 kilobits per second (kbps) and 3.2 Mbps. I2C and I3C protocols may define electrical and timing aspects for signals transmitted on the 2-wire serial bus 230, in addition to data formats and aspects of bus control. In some aspects, the I2C and I3C protocols may define direct current (DC) characteristics affecting certain signal levels associated with the serial bus 230, and/or alternating current (AC) characteristics affecting certain timing aspects of signals transmitted on the serial bus 230.

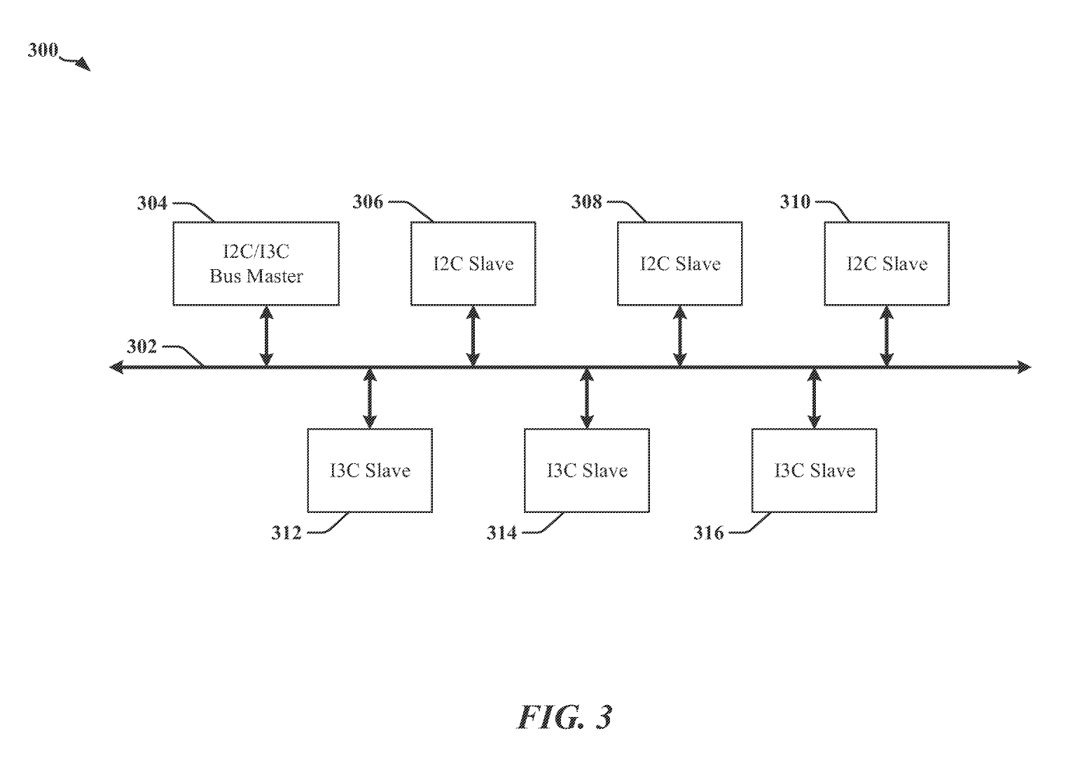

FIG. 3 illustrates a system 300 having a configuration of devices 304, 306, 308, 310, 312, 314 and 316 connected to a serial bus 302, whereby I3C devices 304, 312, 314 and 316 may be adapted or configured to obtain higher data transfer rates over the serial bus 302 using I3C protocols. The I3C devices 304, 312, 314 and 316 may coexist with conventionally configured I2C devices 306, 308, and 310. The I3C devices 304, 312, 314 and 316 may alternatively or additionally communicate using conventional I2C protocols, as desired or needed.

The serial bus 302 may be operated at higher data transfer rates when a master device 304 operates as an I3C bus master when controlling the serial bus 302. In the depicted example, a single master device 304 may serve as a bus master in I2C mode and in an I3C mode that supports a data transfer rate that exceeds the data transfer rate achieved when the serial bus 302 is operated according to a conventional I2C protocol. The signaling used for higher data-rate traffic may take advantage of certain features of I2C protocols such that the higher data-rate traffic can be carried over the serial bus 302 without compromising the functionality of legacy I2C devices 306, 308, 310 and 312 coupled to the serial bus 302.

Timing in an I2C Bus

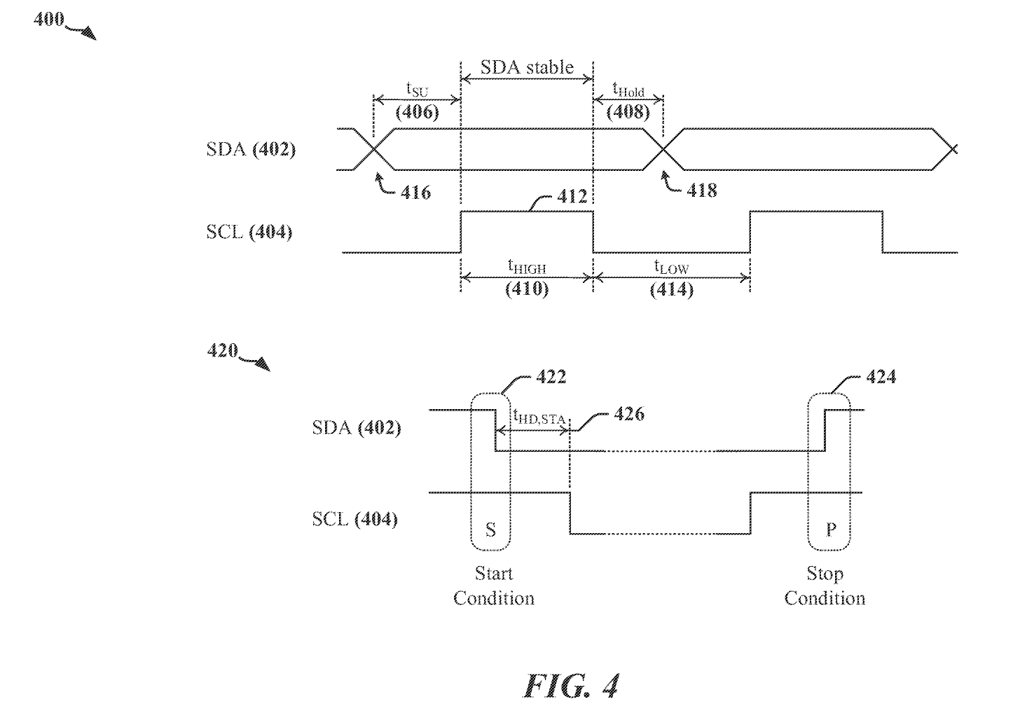

FIG. 4 includes timing diagrams 400 and 420 that illustrate the relationship between the SDA wire 402 and the SCL wire 404 on a conventional I2C bus. The first timing diagram 400 illustrates the timing relationship between the SDA wire 402 and the SCL wire 404 while data is being transferred on the conventionally configured I2C bus. The SCL wire 404 provides a series of pulses that can be used to sample data in the SDA wire 402. The pulses (including the pulse 412, for example) may be defined as the time during which the SCL wire 404 is determined to be in a high logic state at a receiver. When the SCL wire 404 is in the high logic state during data transmission, data on the SDA wire 402 is required to be stable and valid; the state of the SDA wire 402 is not permitted to change when the SCL wire 404 is in the high logic state.

Specifications for conventional I2C protocol implementations (which may be referred to as “I2C Specifications”) define a minimum duration 410 (t_{HIGH}) of the high period of the pulse 412 on the SCL wire 404. The I2C Specifications also define minimum durations for a setup time 406 (tsu) before occurrence of the pulse 412, and a hold time 408 (t_{Hold}) after the pulse 412 terminates. The signaling state of the SDA wire 402 is expected to be stable during the setup time 406 and the hold time 408. The setup time 406 defines a maximum time period after a transition 416 between signaling states on the SDA wire 402 until the arrival of the rising edge of the pulse 412 on the SCL wire 404. The hold time 408 defines a minimum time period after the falling edge of the pulse 412 on the SCL wire 404 until a next transition 418 between signaling states on the SDA wire 402. The I2C Specifications also define a minimum duration 414 for a low period (t_{LOW}) for the SCL wire 404. The data on the SDA wire 402 is typically stable and/or can be captured for the duration 410 (t_{HIGH}) when the SCL wire 404 is in the high logic state after the leading edge of the pulse 412.

The second timing diagram 420 of FIG. 4 illustrates signaling states on the SDA wire 402 and the SCL wire 404 between data transmissions on a conventional I2C bus. The I2C protocol provides for transmission of 8-bit data (bytes) and 7-bit addresses. A receiver may acknowledge transmissions by driving the SDA wire 402 to the low logic state for one clock period. The low signaling state represents an acknowledgement (ACK) indicating successful reception and a high signaling state represents a negative acknowledgement (NACK) indicating a failure to receive or an error in reception.

A START condition 422 is defined to permit the current bus master to signal that data is to be transmitted. The START condition 422 occurs when the SDA wire 402 transitions from high to low while the SCL wire 404 is high. The I2C bus master initially transmits the START condition 422, which may be also be referred to as a start bit, followed by a 7-bit address of an I2C slave device with which it wishes to exchange data. The address is followed by a single bit that indicates whether a read or write operation is to occur. The addressed I2C slave device, if available, responds with an ACK bit. If no I2C slave device responds, the I2C bus master may interpret the high logic state of the SDA wire 402 as a NACK. The master and slave devices may then exchange bytes of information in frames, in which the bytes are serialized such that the most significant bit (MSB) is transmitted first. The transmission of the byte is completed when a STOP condition 424 is transmitted by the I2C master device. The STOP condition 424 occurs when the SDA wire 402 transitions from low to high while the SCL wire 404 is high. The I2C Specifications require that all transitions of the SDA wire 402 occur when the SCL wire 404 is low, and exceptions may be treated as a START condition 422 or a STOP condition 424.

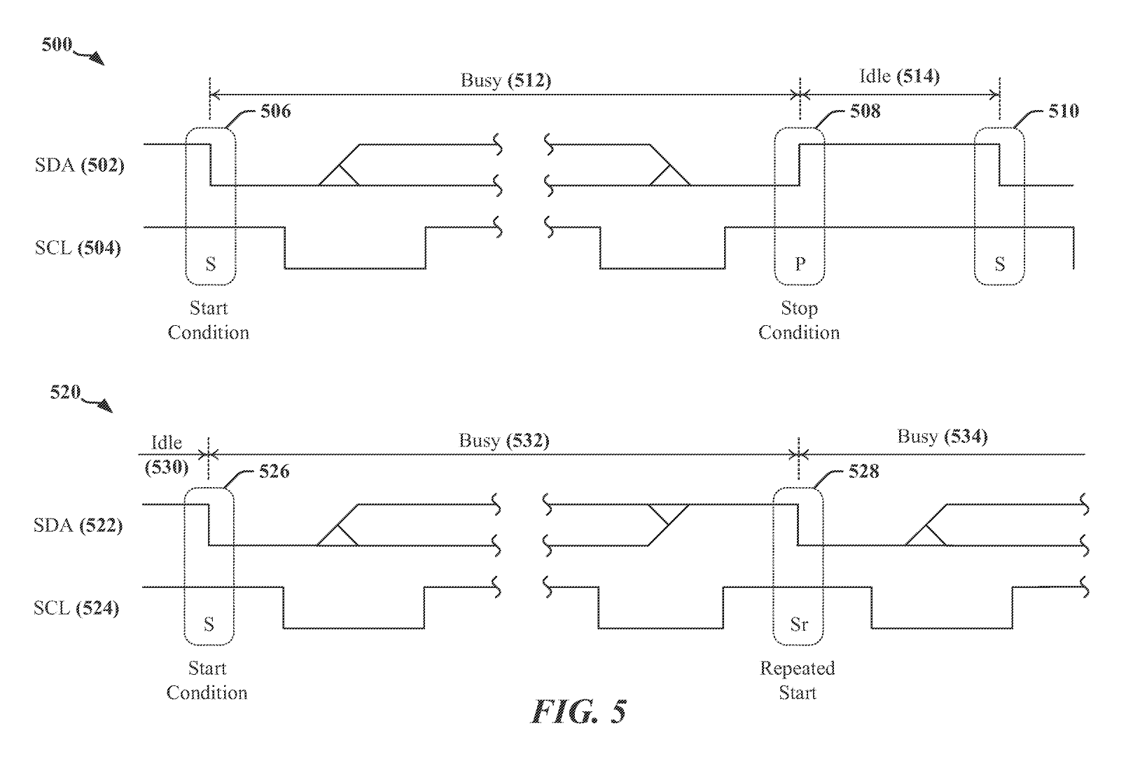

FIG. 5 includes diagrams 500 and 520 that illustrate timing associated with data transmissions on an I2C bus. As illustrated in the first diagram 500, an idle period 514 may occur between a STOP condition 508 and a consecutive START condition 510. This idle period 514 may be prolonged, and may result in reduced data throughput when the conventional I2C bus remains idle between the STOP condition 508 and the consecutive START condition 510. In operation, a busy period 512 commences when the I2C bus master transmits a first START condition 506, followed by data. The busy period 512 ends when the I2C bus master transmits a STOP condition 508 and the idle period 514 ensues. The idle period 514 ends when a second START condition 510 is transmitted.

The second timing diagram 520 illustrates a method by which the number of occurrences of an idle period 514 may be reduced. In the illustrated example, data is available for transmission before a first busy period 532 ends. The I2C bus master device may transmit a repeated START condition 528 (Sr) rather than a STOP condition. The repeated START condition 528 terminates the preceding data transmission and simultaneously indicates the commencement of a next data transmission. The state transition on the SDA wire 522 corresponding to the repeated START condition 528 is identical to the state transition on the SDA wire 522 for a START condition 526 that occurs after an idle period 530. For both the START condition 526 and the repeated START condition 528, the SDA wire 522 transitions from high to low while the SCL wire 524 is high. When a repeated START condition 528 is used between data transmissions, a first busy period 532 is immediately followed by a second busy period 534.

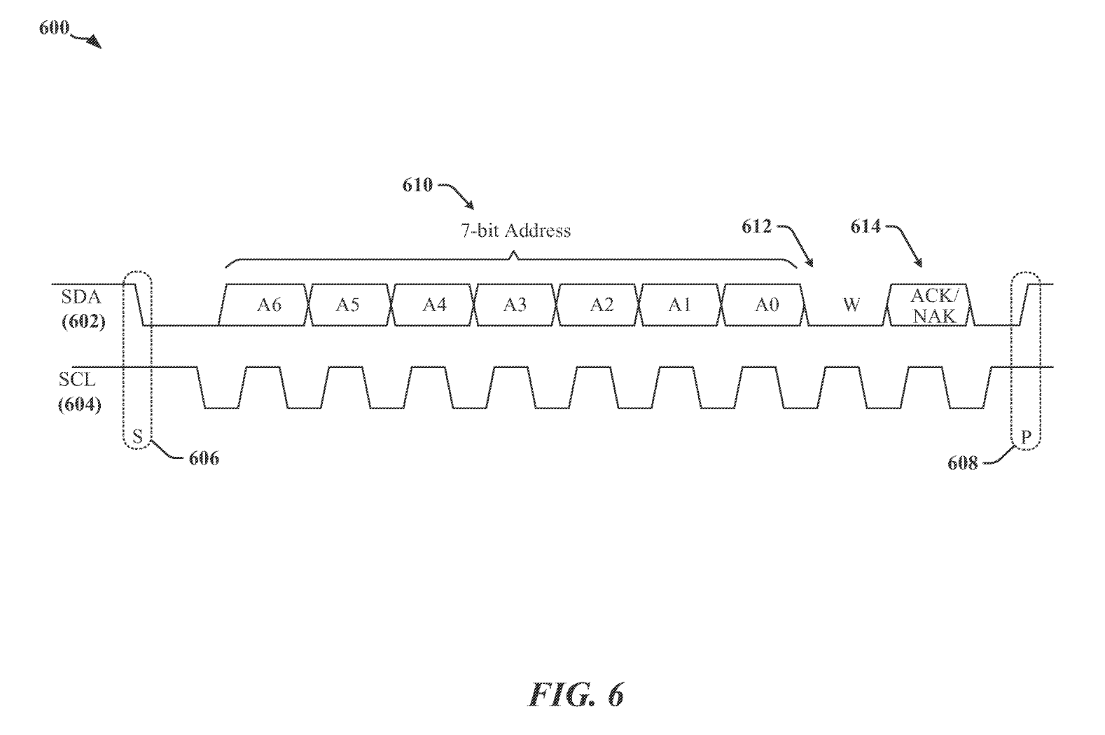

FIG. 6 is a diagram 600 that illustrates an example of the timing associated with a command word sent to a slave device in accordance with I2C protocols. In the example, a master device initiates the transaction with a START condition 606, whereby the SDA wire 602 is driven from high to low while the SCL wire 604 remains high. The master device then transmits a clock signal on the SCL wire 604. The seven-bit address 610 of a slave device is then transmitted on the SDA wire 602. The seven-bit address 610 is followed by a Write/Read command bit 612, which indicates “Write” when low and “Read” when high. The slave device may respond in the next clock interval 614 with an acknowledgment (ACK) by driving the SDA wire 602 low. If the slave device does not respond, the SDA wire 602 is pulled high and the master device treats the lack of response as a NACK. The master device may terminate the transaction with a STOP condition 608 by driving the SDA wire 602 from low to high while the SCL wire 604 is high. This transaction can be used to determine whether a slave device with the transmitted address coupled to the I2C bus is in an active state.

The master device relinquishes control of the SDA wire 602 after transmitting the Write/Read command bit 612 such that the slave device may transmit an acknowledgment (ACK) bit on the SDA wire 602. In some implementations, open-drain drivers are used to drive the SDA wire 602. When open-drain drivers are used, the SDA drivers in the master device and the slave device may be active concurrently. In other implementations, push-pull drivers are used to drive the SDA wire 602. When push-pull drivers are used, the signaling state of the SDA wire 602 may be indeterminate when the SDA drivers in both the master device and the slave device are active concurrently.

Timing in an I3C Bus

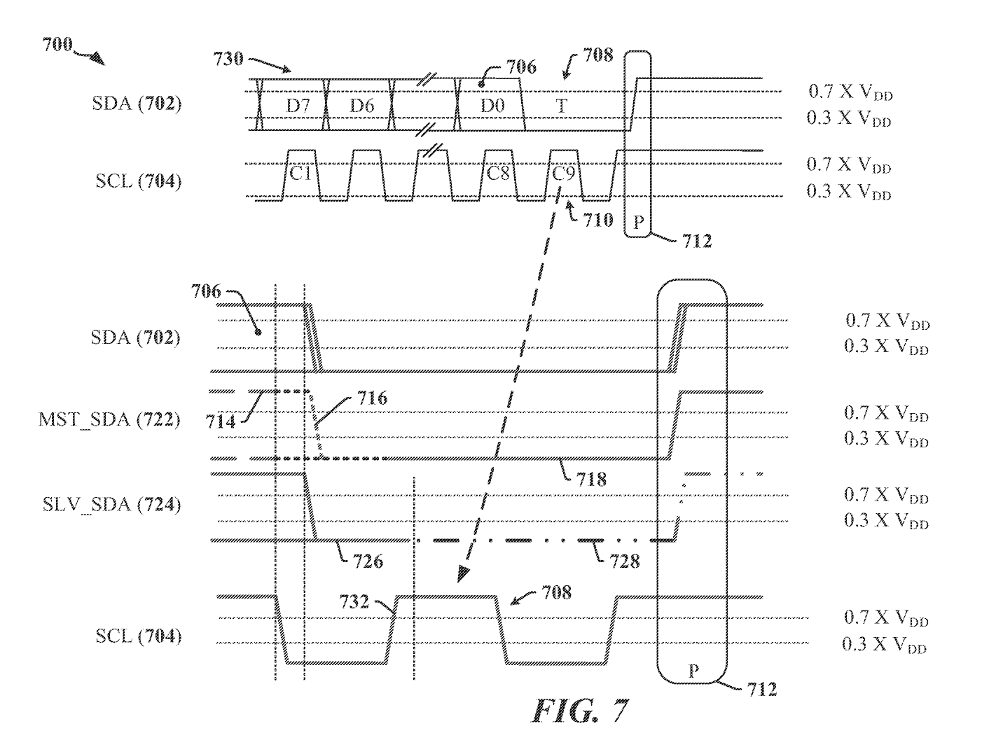

FIG. 7 is a diagram 700 that illustrates an example of the timing associated with a data read from a slave device in accordance with a single data rate (SDR) I3C protocol. In the example, a master device provides a clock signal (SCL 704) on a first wire that controls timing of a data signal (SDA 702) transmitted on a second wire. SDA 702 can be bidirectional where data can be transmitted from a master device to a slave device in a first transaction or from a slave device to a master device in a second transaction. Certain I3C devices may include drivers that can drive SDA 702 in an open-drain mode and/or a push-pull mode. In the open-drain mode, the drivers can tolerate concurrent driving of the SDA wire 602 by bus and master devices. Drivers operated in the push-pull mode may switch between signaling states faster that drivers operated in the open-drain mode. In accordance with I3C protocols, the serial bus may be in a state of operation where I3C device drivers are operated in push-pull mode and the master device and the slave device generally cannot drive SDA 702 concurrently.

FIG. 7 includes an example of bus turnaround in accordance with I3C protocols. The first timeline 722 illustrates a master device line driver that may switch between different modes of operation during the bus turnaround. The master device line driver associated with the first timeline 722 is coupled to SDA 702. During transmission of a data byte 730 by the slave device, the line driver in the master device is in a high-impedance mode 714 and does not create any conflicts with the corresponding driver of the slave device. As the last bit 706 of the data byte 730 is being transmitted by the slave device, the line driver of the master device enters an open-drain mode 716 before actively driving SDA 702 in an active mode 718.

The mode of operation of the line driver in the slave device that is coupled to SDA 702 is illustrated in the second timeline 724. The line driver of the slave device is initially in an active mode 726, driving the last bit 706 of the data byte 730, and before a transition bit 708 (T bit) is driven by the master device. The line driver of the slave device then enters a high impedance mode 728 as the master driver takes control of SDA 702, after the rising edge 732 of a clock pulse 710 used to sample the T bit 708.

In the illustrated example, the master device transmits a transition bit 708 to establish the timing condition required before a STOP condition 712 is transmitted. The master device may alternatively transmit a repeated START condition to continue receiving data from the slave device after the master driver enters the active mode 718.

In some applications, an I3C bus may be used to carry a variety of data traffic between different devices. In some instances, a master device may determine that an exception has occurred that requires termination of a current transaction. The exception may be caused by an error in data transmission, an event detected by a slave device or a master device. The exception may be generated by an application processor. The exception may be related to the availability of priority traffic to be transmitted over the I3C bus. If a bus master is actively transmitting on the I3C bus, then a START condition or repeated START condition may be immediately transmitted to begin a transmission of a command related to the exception. For example, the master device may transmit a START condition or repeated START condition while terminating an in-progress transmission of a command or a byte of data. The master device may then issue a command to read or write high-priority data. A slave device that was involved in a transaction prior to the occurrence of the exception recognizes the START condition or repeated START condition and determines that an error has occurred in the current transmission. The slave device may reset the state of its bus interface to prepare for the next bus activity.

If a bus master is reading data from a slave device coupled to the I3C bus using push-pull drivers, then a conventional master device may issue a command related to the exception after the slave device has completed transmission of a current byte and entered high-impedance mode and the master device can transmit a START condition or repeated START condition. The delay between occurrence of an exception and the termination of a read can affect system responsiveness. When open-drain connectors are used, the bus master may interrupt a READ transaction by transmitting a repeated START condition, which causes slave devices to reset their bus interfaces.

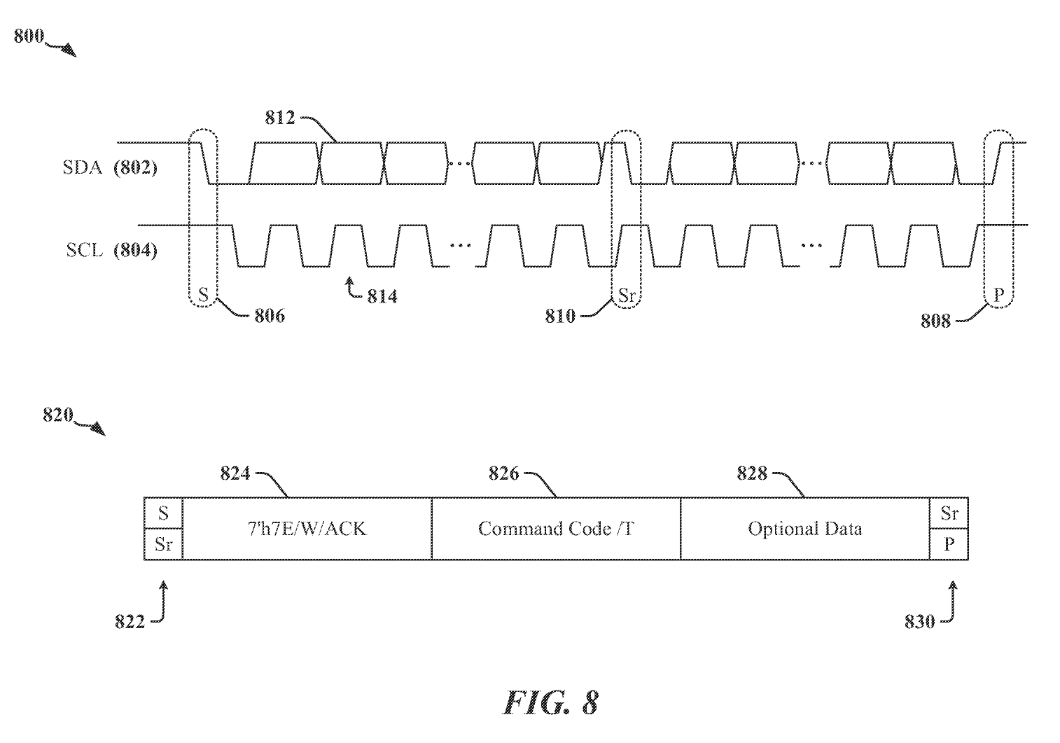

FIG. 8 illustrates aspects related to the operation of a serial bus in accordance with I3C SDR protocols. The timing diagram 800 illustrates signaling on a serial bus when the serial bus is operated in one SDR mode of operation defined by I3C specifications. Data transmitted on a first wire (the SDA wire 802) of the serial bus may be captured using a clock signal transmitted on a second wire (the SCL wire 804) of the serial bus. During data transmission, the signaling state 812 of the SDA wire 802 is expected to remain constant for the duration of the pulses 814 when the SCL wire 804 is at a high voltage level. Transitions on the SDA wire 802 when the SCL wire 804 is at the high voltage level indicate a START condition 806, a STOP condition 808 or a repeated START 810.

On an I3C serial bus, a START condition 806 is defined to permit the current bus master to signal that data is to be transmitted. The START condition 806 occurs when the SDA wire 802 transitions from high to low while the SCL wire 804 is high. The bus master may signal completion and/or termination of a transmission using a STOP condition 808. The STOP condition 808 is indicated when the SDA wire 802 transitions from low to high while the SCL wire 804 is high. A repeated START 810 may be transmitted by a bus master that wishes to initiate a second transmission upon completion of a first transmission. The repeated START 810 is transmitted instead of, and has the significance of a STOP condition 808 followed immediately by a START condition 806. The repeated START 810 occurs when the SDA wire 802 transitions from high to low while the SCL wire 804 is high.

The bus master may transmit an initiator 822 that may be a START condition 806 or a repeated START 810 prior to transmitting an address of a slave, a command, and/or data. FIG. 8 illustrates a command code transmission 820 by the bus master. The initiator 822 may be followed in transmission by a predefined command 824 indicating that a command code 826 is to follow. The command code 826 may, for example, cause the serial bus to transition to a desired mode of operation. In some instances, data 828 may be transmitted. The command code transmission 820 may be followed by a terminator 830 that may be a STOP condition 808 or a repeated START 810.

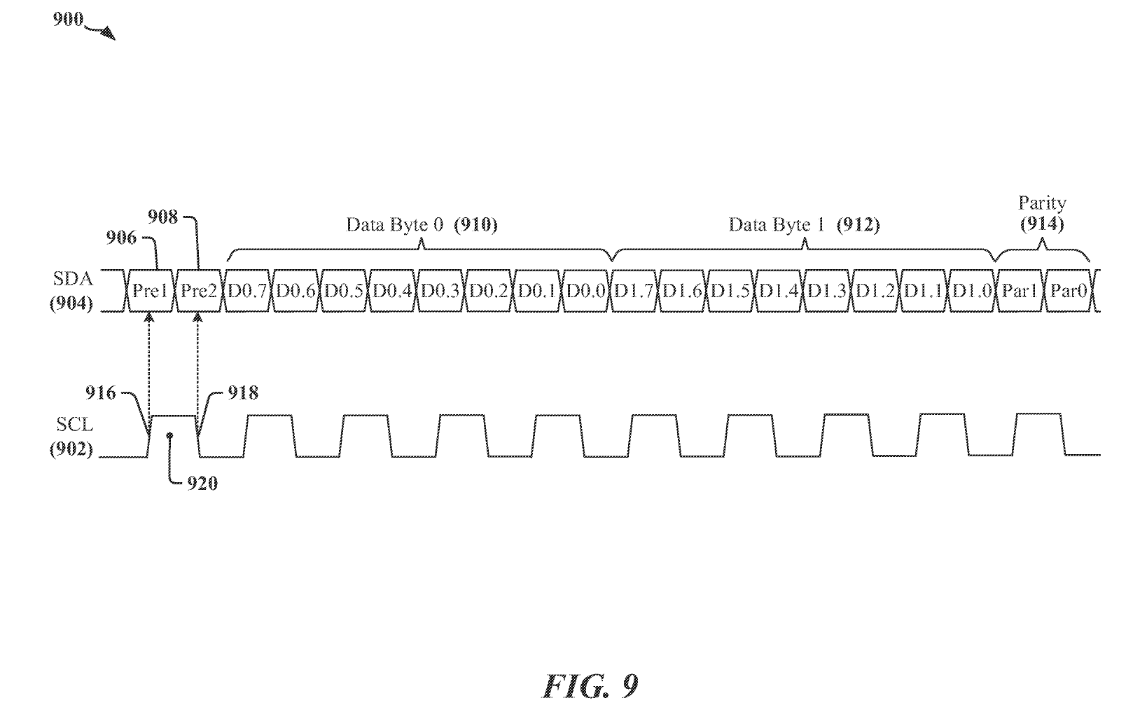

Certain serial bus interfaces support signaling schemes that provide higher data rates. In one example, I3C specifications define multiple high data rate (HDR), including a high data rate, double data rate (HDR-DDR) mode in which data is transferred at both the rising edge and the falling edge of the clock signal. FIG. 9 is a timing diagram 900 that illustrates an example of a transmission in an I3C HDR-DDR mode, in which data transmitted on the SDA wire 904 is synchronized to a clock signal transmitted on the SCL wire 902. The clock signal includes pulses 920 that are defined by a rising edge 916 and a falling edge. A master device transmits the clock signal on the SCL wire 902, regardless of the direction of flow of data over the serial bus. A transmitter outputs one bit of data at each edge 916, 918 of the clock signal. A receiver captures one bit of data based on the timing of each edge 916, 918 of the clock signal.

Certain other characteristics of an I3C HDR-DDR mode transmission are illustrated in the timing diagram 900 of FIG. 9. According to certain I3C specifications, data transferred in HDR-DDR mode is organized in words. A word generally includes 16 payload bits, organized as two 8-bit bytes 910, 912, preceded by two preamble bits 906, 908 and followed by two parity bits 914, for a total of 20 bits that are transferred on the edges of 10 clock pulses. The integrity of the transmission may be protected by the transmission of the parity bits 914.

In HDR-DDR mode, the physical SDA wire 904 is driven actively by the sender of the data, and the receiver has no ability to send a request in a signal on the SDA wire 904 to cease or suspend transmissions. A request to cease or suspend transmission may be desirable to implement a flow-control capability for the serial link. Absent the availability of flow-control, the receiver must absorb all transmitted data, irrespective of the ability of the receiver to process, store or forward the data. In some instances, flow-control techniques may be useful or desirable when memory space of the receiver has been exhausted, the transfer delivers data too quickly, or the receiver is busy or burdened handling other tasks, etc.

In some implementations of the I3C standards, the I3C HDR-DDR protocol may support certain basic flow-control for read procedures, where a slave device is transferring data to a bus master device. Flow-control for a read procedure enables the master device to terminate a read transaction. Certain aspects disclosed herein enable devices coupled to a serial bus to provide flow-control for I3C HDR-DDR write procedures, where the master device or a peer slave device is transmitting data to the slave device. Flow-control procedures implemented for I3C HDR-DDR write procedures enables a slave device to signal a request to the master device to terminate a write transaction immediately.

According to certain aspects disclosed herein, a slave device may request the master device to terminate a write transaction by manipulating one or more preamble bits 906, 908. In some instances, a master device may assume control of the serial bus and terminate the current transaction in response to the request to terminate write transaction. In other instances, the sender can either continue the data transfer. Termination or continuation of a transaction may depend on the type of transaction. In one example, a master device may initiate termination of a transaction by transmitting the HDR Restart or EXIT pattern.

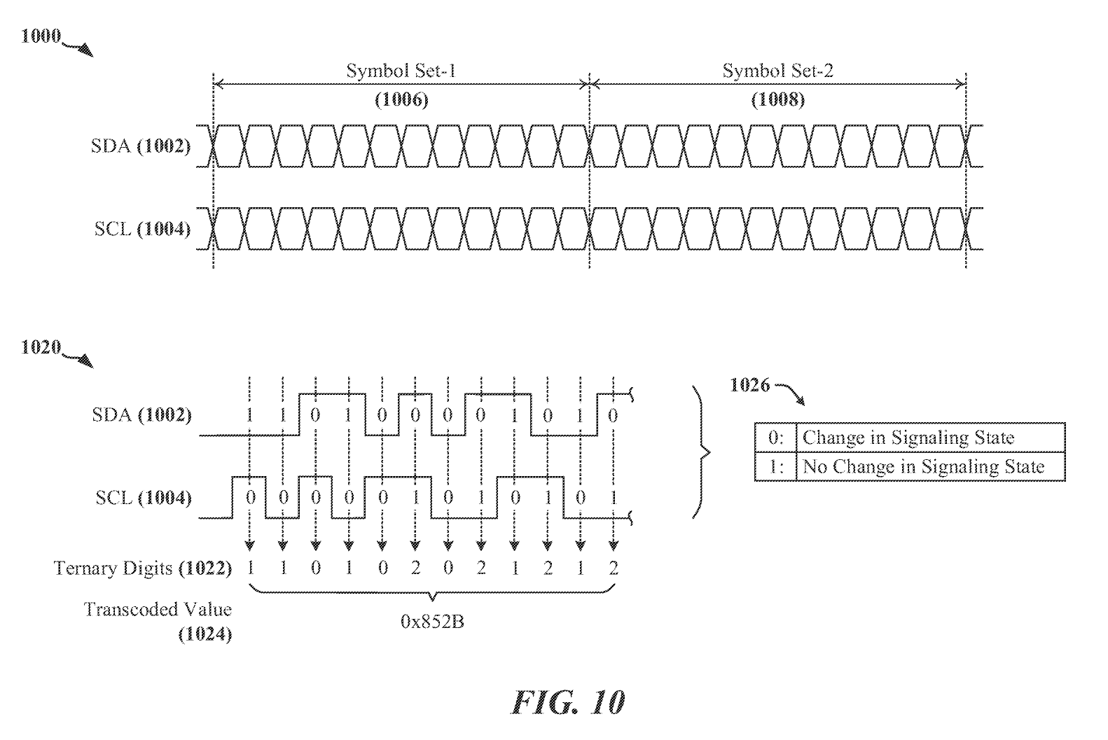

FIG. 10 includes an example of signaling 1020 that illustrates decoding of an HDR Ternary mode transmission in accordance with certain I3C protocols. Ternary digits 1022 are generated based each transition between signaling states of the SDA wire 402 and the SCL wire 404. The table 1026 illustrates one method of assigning ternary values to a transition in signaling state of the SDA wire 402 and the SCL wire 404. For example, a binary number representing the transition may have its least significant bit set to ‘0’ when a change in signaling state was observed on the SDA wire 402 and set to ‘1’ when no change in signaling state was observed on the SDA wire 402. The most significant bit of the binary number may be set to ‘0’ when a change in signaling state was observed on the SCL wire 404 and set to ‘1’ when no change in signaling state was observed on the SCL wire 404. Since a transition must occur on at least one wire 402 or 404, the binary number is not set to ‘11’ and the resultant 2-bit binary number represents a ternary value. When all 12 symbols have been received, each pair of digits in the 12-bit binary number may be transcoded to obtain an 18-bit data word 1024.

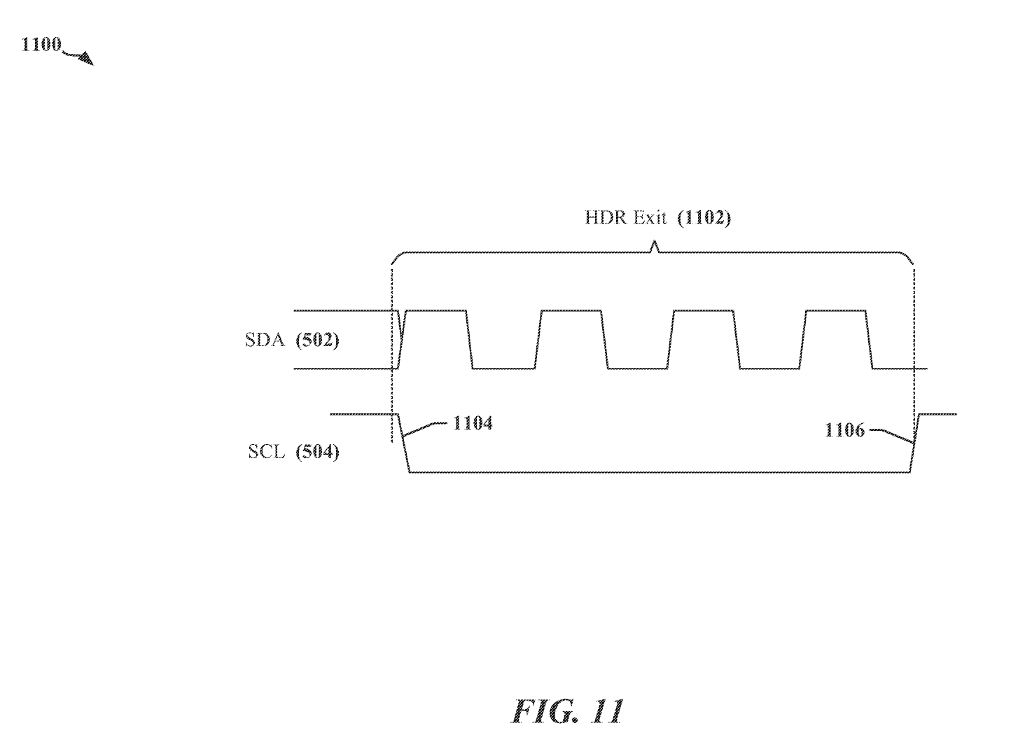

FIG. 11 illustrates an example of signaling 1100 transmitted on the SDA wire 1004 and SCL wire 902, 1002 to initiate certain mode changes. The signaling 1100 is defined by I3C protocols for use in initiating restart, exit and/or break from I3C HDR modes of communication. The signaling 1100 includes an HDR Exit 1102 that may be used to cause an HDR break or exit. The HDR Exit 1102 commences with a falling edge 1104 on the SCL wire 902, 1002 and ends with a rising edge 1106 on the SCL wire 902, 1002. While the SCL wire 902, 1002 is in low signaling state, four pulses are transmitted on the SDA wire 904, 1004. I2C devices ignore the SDA wire 904, 1004 when no pulses are provided on the SCL wire 902, 1002.

Certain aspects disclosed herein are described in relation to serial bus operated in an I3C SDR mode. The example of I3C SDR mode is selected for convenience of description and illustration. Certain concepts disclosed herein are equally applicable when the serial bus is serial bus operated in an I3C HDR modes. It is contemplated that principles and concepts disclosed herein can be applied to other types of communication interface in which a transaction includes states that can allow the transaction to be interrupted by direct participants. Certain aspects disclosed herein permit a non-participant intervene in a transaction and/or to request the early termination of the transaction. Certain aspects disclosed herein relate to configurable intervention capabilities whereby devices that are adapted to be capable of intervention can be statically or dynamically configured to intervene under certain operational conditions including, for example, when high priority data or signaling is available at the non-participating device.

Accelerated I3C Stop Initiated by a Transaction Insider

According to certain aspects disclosed herein, a master device that is configured to communicate using push-pull drivers in accordance with I3C protocols and specifications may be adapted to accelerate or force turnaround while reading from a slave device. The master device and the insider slave device are parties to the transaction and may be referred to herein as insider devices. In a first aspect, acceleration may be accomplished by advancing the transmission of a repeated START condition and/or a STOP condition when the last bit of a data frame or data byte transmitted by the slave is represented by a high voltage level. In a second aspect, acceleration may be accomplished by advancing the transmission of a repeated START condition and/or a STOP condition when the last bit of a data frame or data byte transmitted by the slave is not represented by a high voltage level. In some instances, accelerated turnaround may be employed to terminate a transmission by an insider slave device before completion of the transmission.

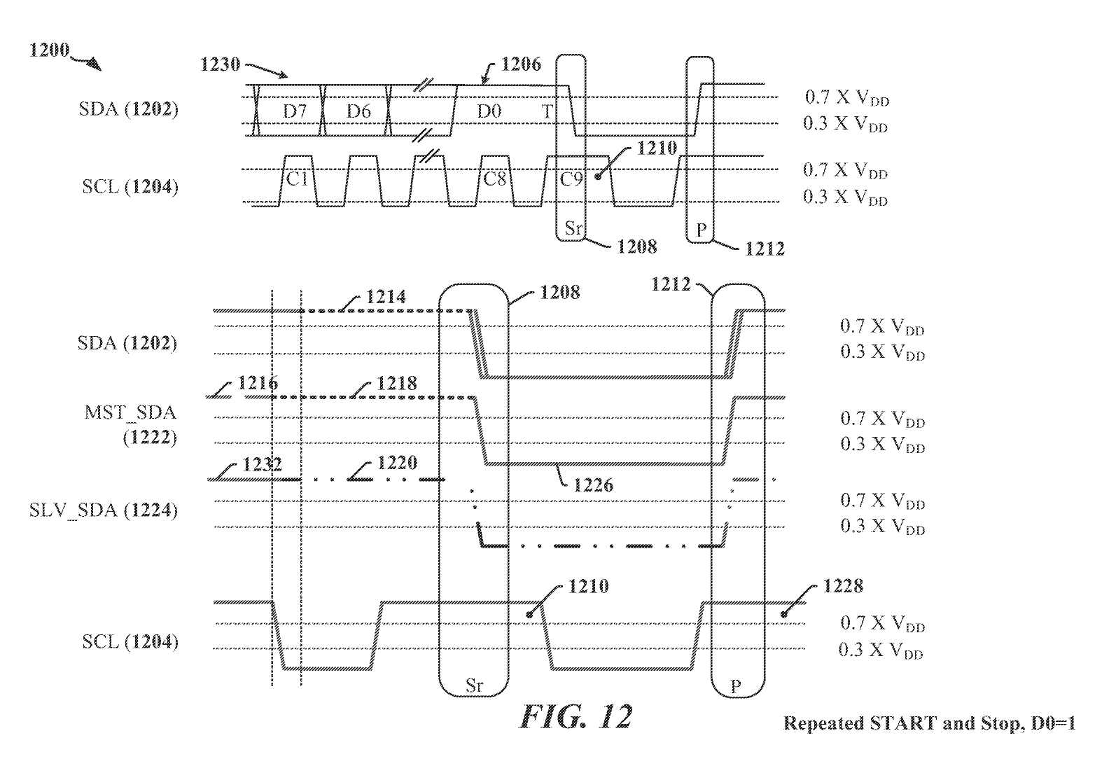

FIG. 12 includes timing diagrams 1200 that illustrate a first example in which a repeated START condition 1208 may be initiated early by an insider device. In some instances, the repeated START condition 1208 may be asserted to terminate a transaction in which a slave device is transmitting data and may have data remaining to be transmitted. The example illustrated in FIG. 12 may relate to an instance when an exception is detected during transmission of a data frame or data byte 1230, and this example may be characterized as a “stop and stop” example. The mode of operation of the line driver in the master device that is coupled to SDA 1202 is illustrated in the first timeline 1222. During transmission of a data byte 1230 by the slave device, the line driver in the master device is in a high-impedance mode 1216 and does not create any conflicts with the corresponding driver of the slave device. As the last bit 1206 of the data byte 1230 is being transmitted by the slave device, the master device recognizes that the SDA wire 1202 is in a high voltage state. The master driver may cause the line driver of the master device to enter an open-drain mode 1218 upon detection of the high voltage state corresponding to the last bit 1206 of the data byte 1230. The master device may actively drive the SDA wire 1202 to a low voltage during the clock pulse 1210 corresponding to the Transition (or control) bit that follows the last bit 1206 of the data byte 1230, upon placing the line driver in an active driving mode 1226. The master device may increase the duration of the clock pulse 1210 corresponding to the last bit 1206 of the data byte 1230 to provide adequate setup timing for a repeated START condition 1208. During the next clock pulse 1228, the master device may transmit a STOP condition 1212 to terminate transmissions on the serial bus.

The mode of operation of the line driver in the slave device that is coupled to SDA 1202 is illustrated in the second timeline 1224. The line driver of the slave device is initially in an active mode 1232. When the slave device recognizes that the last bit 1206 of the data byte 1230 causes SDA 1202 to go to a high state, the slave device may cause its driver to enter high impedance mode 1220 to permit the master driver the option of takes control of SDA 1202. SDA 1202 may be pulled high by a termination resistor when the slave device enters high impedance mode 1220, and before the master device enters an active driving mode 1226. In one example, the termination resistor is an open-drain class pull-up resistor that is coupled to SDA 1202 through a switch controlled by the master device.

The master device may enter the open-drain mode 1218 (with pull-up) after, or while transmitting a falling edge of SCL 1204. The master device may extend the duration of the voltage high state on SCL 1204 to comply with timing requirements associated with open-drain mode 1218. After a sufficient delay, which is enabled by the extended clock pulse 1210, the Master pulls SDA 1202 low, thereby providing a repeated START condition (repeated START condition 1208). The master device keeps the SDA wire 1202 in the low state for a period of time sufficient to comply with timing requirements associated with open-drain mode 1218. After the next rising edge on SCL 1204, the master device drives SDA 1202 high, providing the STOP condition 1212.

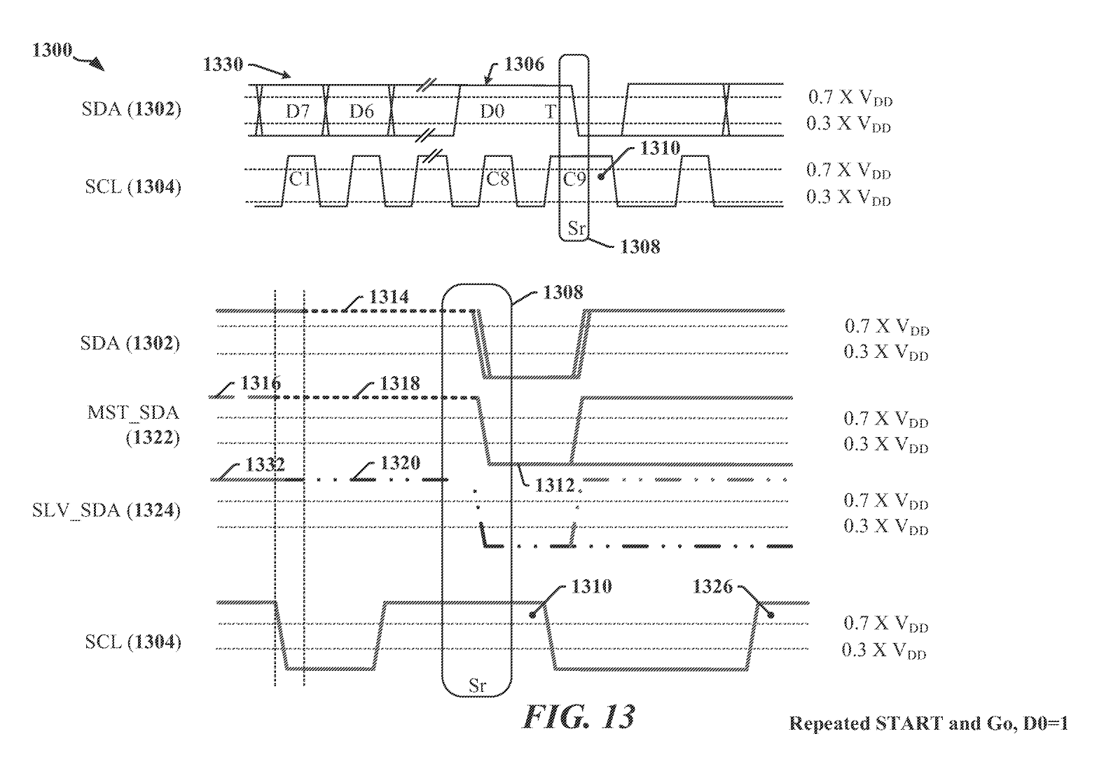

FIG. 13 includes timing diagrams 1300 that illustrate a second example in which a repeated START condition 1308 may be initiated early by an insider device. In some instances, the repeated START condition 1308 may be asserted to terminate a transaction in which a slave device is transmitting data and may have data remaining to be transmitted. The example illustrated in FIG. 13 may relate to an instance when an exception is detected during transmission of a data frame or data byte 1330, and this example may be characterized as a “stop and go” example. The mode of operation of the line driver in the master device that is coupled to SDA 1302 is illustrated in the first timeline 1322. During transmission of a data byte 1330 by the slave device, the line driver in the master device is in a high-impedance mode 1316 and does not create any conflicts with the corresponding driver of the slave device. As the last bit 1306 of the data byte 1330 is being transmitted by the slave device, the master device recognizes that the SDA wire 1302 is in a high voltage state. The master driver may cause the line driver of the master device to enter an open-drain mode 1318 upon detection of the high voltage state corresponding to the last bit 1306 of the data byte 1330. The master device may actively drive the SDA wire 1302 to a low voltage during the clock pulse 1310 corresponding to the Transition (or control) bit that follows the last bit 1306 of the data byte 1330, upon placing the line driver in an active mode 1312. The master device may increase the duration of the clock pulse 1310 corresponding to the last bit 1306 of the data byte 1330 to provide adequate setup timing for a repeated START condition 1308. On the next clock pulse 1326, the master device may begin a new transaction on the serial bus.

The mode of operation of the line driver in the slave device that is coupled to SDA 1302 is illustrated in the second timeline 1324. The line driver of the slave device is initially in an active mode 1332. When the slave device recognizes that the last bit 1306 of the data byte 1330 causes SDA 1302 to go to a high state, the slave device may cause its driver to enter high impedance mode 1320 to permit the master driver the option of takes control of SDA 1302. SDA 1302 may be pulled high by a termination resistor when the slave device enters high impedance mode 1320, and before the master device enters an active mode 1312. In one example, the termination resistor is implemented using an open-drain class pull-up resistor that is coupled to SDA 1302 through a switch controlled by the master device.

In one example, the master device enters the open-drain mode 1318 (with pull-up) after, or while transmitting a falling edge of SCL 1304. The master device may extend the duration of the voltage high state on SCL 1304 to comply with timing requirements associated with open-drain mode 1318. After a sufficient delay, which is enabled by the extended clock pulse 1310, the master device pulls SDA 1302 low, thereby providing a repeated START condition (repeated START condition 1308). The master device keeps the SDA wire 1302 in the low state for a period of time sufficient to comply with timing requirements associated with open-drain mode 1318. After the falling edge of the clock pulse 1310, the master device may drive SDA 1302 in accordance with the next data bit that needs to be transmitted. The master device may then provide a rising edge of the next clock pulse on SCL 1304.

When the slave device is configured to support accelerated Stop/Start, the slave device enters the high-impedance mode during the last bit transmission period after every byte that terminates with the slave device transmitting a high voltage on the SDA wire 1202, 1302. Different modes of communication may be supported by the slave device such that the slave device may enable and disable support for accelerated STOP/START. In one example, the slave device enables a first mode of communication in response to a command received at the slave device, where accelerated STOP/START is supported in the first mode of communication. The slave device may disable the first mode of communication in response to a command received at the slave device. The command may be transmitted by a bus master, application processor or other entity.

The slave device may configure its line driver for a high-impedance mode. In one example, the slave device may gate a transistor of the line driver to cause the output of the line driver to present a high impedance to SDA 1202, 1302. It will be appreciated that impedance of the SDA wire 1202, 1302 may be defined by another device that is not in high-impedance mode.

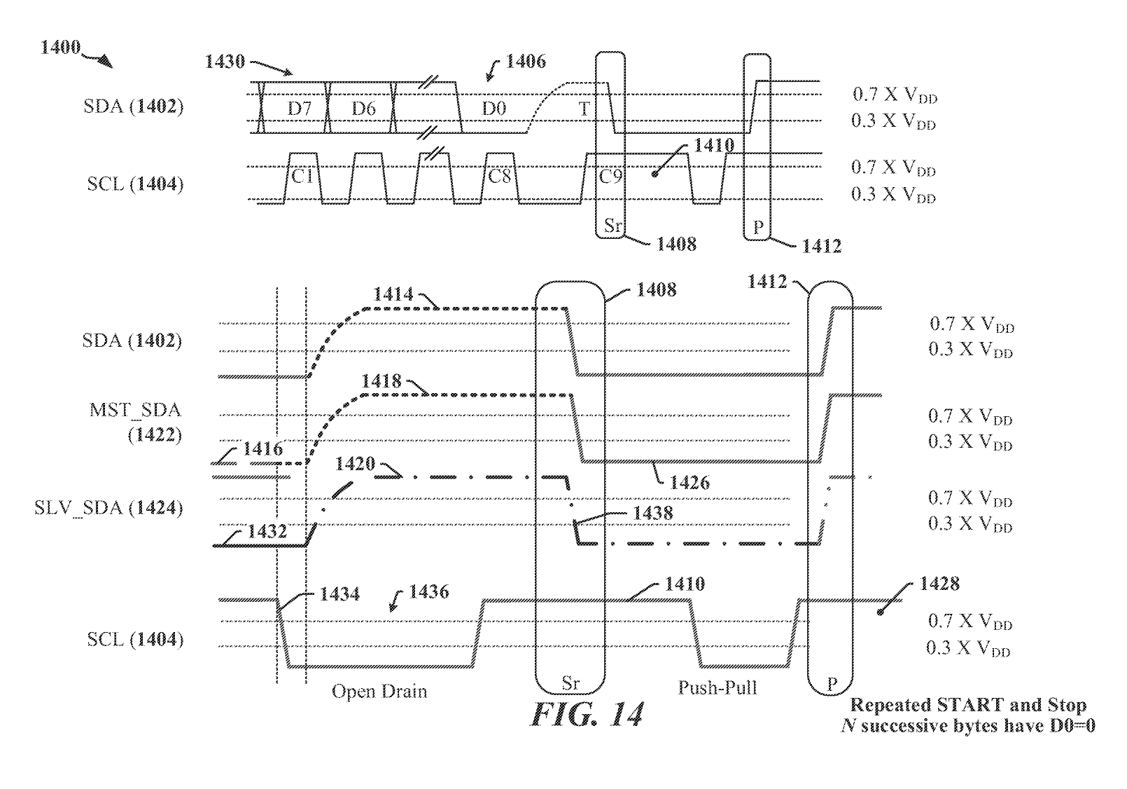

FIG. 14 includes timing diagrams 1400 that illustrate a third example in which a repeated START condition 1408 may be initiated early by an insider device. In some instances, the repeated START condition 1408 may be asserted to terminate a transaction in which a slave device is transmitting data and may have data remaining to be transmitted. The example illustrated in FIG. 14 may relate to an instance when an exception is detected during transmission of a data frame or data byte 1430, and this example may be characterized as a “stop and stop” example. The mode of operation of the line driver in the master device that is coupled to SDA 1402 is illustrated in the first timeline 1422. During transmission of a data byte 1430 by the slave device, the line driver in the master device is in a high-impedance mode 1416 and does not create any conflicts with the corresponding driver of the slave device. As the last bit 1406 of the data byte 1430 is being transmitted by the slave device, the master device recognizes that the SDA wire 1402 is in a low voltage state. The slave device continues driving the last bit 1406 in compliance with timing specifications for the bus, and in order to permit the last bit 1406 to be sampled at a receiver. In conventional systems, the master device has no opportunity to drive SDA 1402 in order to transmit a repeated START condition.

According to certain aspects disclosed herein, the master device may be adapted to extend the clock following the last bit 1406 when the data byte 1430 is the Nth byte that ends in a low voltage state. The slave device may be adapted to release SDA 1402 after transmitting the last bit 1406 of the Nth sequentially transmitted byte that ends in a low voltage state. The master device may then transmit a repeated start condition. The value of N may be selected based on application, type of data transferred over the serial bus and other factors. The value of N may be selected based on a compromise between overhead introduced by increasing clock periods at the end of every Nth byte and latency, where the latency relates to the time elapsed before the slave transmission can be stopped. The value of N may determine worst case latency, and in many implementations, N is greater than 1.

In one example, N may be selected based on probabilities and may be configured to have a value of 4. In this example, it may be assumed that the voltage state of the last bit 1406 of each byte occurs at random and the probability of the last bit 1406 being in the low voltage state is 0.5, occurrence of a sequence of 2 bytes each with the last bit 1406 set to the low voltage state bits has a probability of 0.5×0.5=0.25, occurrence of a sequence of 3 bytes each with the last bit 1406 set to the low voltage state bits has a probability of 0.5×0.5×0.5=0.125, and occurrence of a sequence of 4 bytes each with the last bit 1406 set to the low voltage state bits has a probability of 0.5×0.5×0.5×0.5=0.0625. The technique disclosed herein may be seldom used (6.25% of the time) when N=4.

After detecting a sequence of N successive bytes whose last bit causes SDA 1402 to be in a low voltage state, the master device may initiate a falling edge 1434 on the pulse in SCL 1404 that corresponds to the last bit 1406 of the Nth byte. The master may then enable an open-drain class pull-up on SDA 1402. In one example, the open-drain class pull-up may include a resistor that is coupled to SDA 1402 through a switch controlled by the master device. After elapse of a period defined for clock-to-data turnaround and master-to-slave time of flight (e.g., signaling delay between master and slave), the slave releases SDA 1402 and causes its driver to enter a high-impedance mode. The master device causes the clock signal transmitted on SCL 1404 to enter an open-drain timing mode, in which SCL 1404 has an extended low period 1436 and an extended high period 1410. SDA 1402 rises to a high voltage level 1414 due to the pull-up by the open-drain class pull-up structure in the master driver, and while the output of the slave presents a high impedance to the bus.

SDA 1402 reaches the high voltage level 1414 while SCL 1404 is low. The master then drives SCL 1404 high. The extended high period 1410 of SCL 1404 provides sufficient delay for the master to generate a repeated start condition 1408 by pulling SDA 1402 low. During the next clock pulse 1428, the master may provide a stop condition 1412.

The mode of operation of the line driver in the slave device that is coupled to SDA 1402 is illustrated in the second timeline 1424. The line driver of the slave device is initially in an active mode 1432. When the slave device recognizes that the last bit 1406 of the Nth data byte 1430 causes SDA 1402 to go to a LOW state, the slave device may cause its driver to enter high impedance mode 1420 to permit the master driver the option of takes control of SDA 1402. SDA 1402 may be pulled high by a termination resistor when the slave device enters high impedance mode 1420, and before the master device enters an active driving mode 1426. In one example, the termination resistor is an open-drain class pull-up resistor that is coupled to SDA 1402 through a switch controlled by the master device.

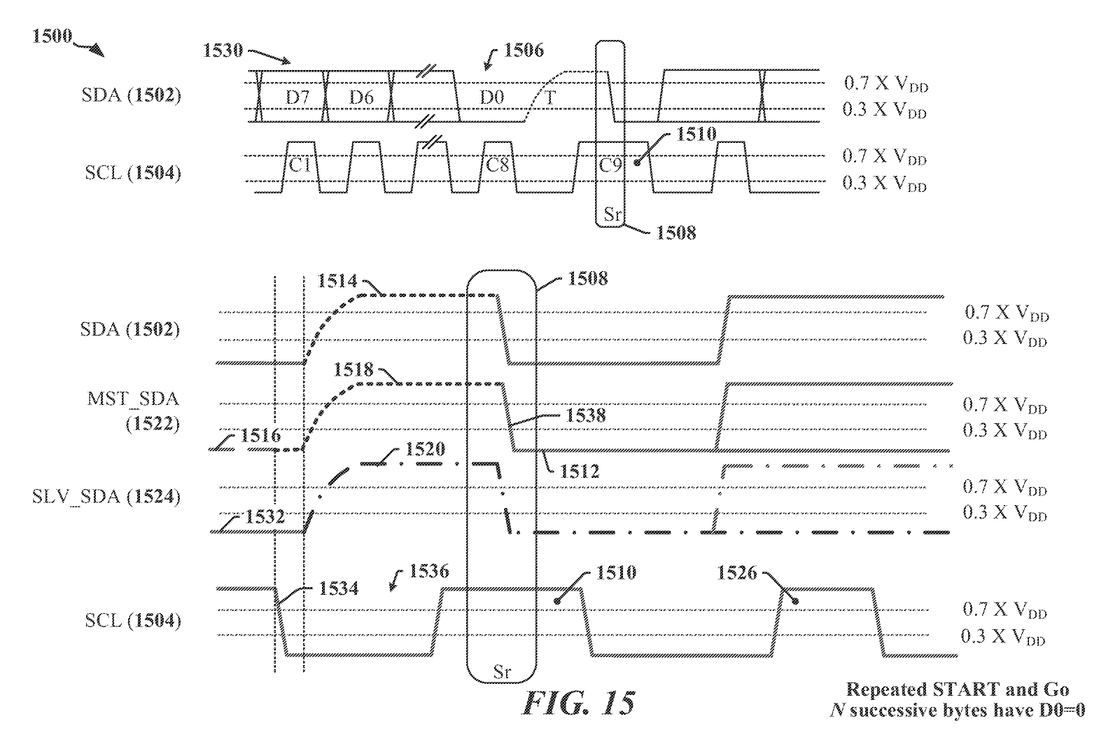

FIG. 15 includes timing diagrams 1500 that illustrate a fourth example in which a repeated START condition 1508 may be initiated early by an insider device. In some instances, the repeated START condition 1508 may be asserted to terminate a transaction in which a slave device is transmitting data and may have data remaining to be transmitted. The example illustrated in FIG. 15 may relate to an instance when an exception is detected during transmission of a data frame or data byte 1530, and this example may be characterized as a “Repeated START and Go” example. The mode of operation of the line driver in the master device that is coupled to SDA 1502 is illustrated in the first timeline 1522. During transmission of a data byte 1530 by the slave device, the line driver in the master device is in a high-impedance mode 1516 and does not create any conflicts with the corresponding driver of the slave device. As the last bit 1506 of the data byte 1530 is being transmitted by the slave device, the master device recognizes that the SDA wire 1502 is in a low voltage state. The slave device continues driving the last bit 1506 in compliance with timing specifications for the bus, and in order to permit the last bit 1506 to be sampled at a receiver. In conventional systems, the master device has no opportunity to drive SDA 1502 in order to transmit a repeated start condition.

According to certain aspects disclosed herein, the master device may be adapted to extend the clock following the last bit 1506 when the data byte 1530 is the Nth sequentially-transmitted byte that ends in a low voltage state. The slave device may be adapted to release SDA 1502 after transmitting the last bit 1506 of the data byte that ends in a low voltage state. The master device may then transmit a repeated start condition. The value of N may be selected based on application, type of data transferred over the serial bus and other factors. The value of N may be selected based on a compromise between overhead introduced by increasing clock periods at the end of every Nth byte and latency, where the latency relates to the time elapsed before the slave transmission can be stopped. The value of N determines worst case latency.

After detecting a sequence of N successive bytes whose last bit causes SDA 1402 to be in a low voltage state, the master device may initiate a falling edge 1534 on the pulse in SCL 1504 that corresponds to the last bit 1506 of the Nth byte. The master may then enable an open-drain class pull-up on SDA 1502. In one example, the open-drain class pull-up may include a resistor that is coupled to SDA 1502 through a switch controlled by the master device. After elapse of a period defined for clock-to-data turnaround and master-to-slave time of flight (e.g., signaling delay between master and slave), the slave releases SDA 1502 and causes its driver to enter a high-impedance mode. The master device causes the clock signal transmitted on SCL 1504 to enter an open-drain timing mode, in which SCL 1504 has a pulse 1510 with an extended high period and an associated extended low period 1536. SDA 1502 rises to a high voltage level 1514 due to the pull-up by the open-drain class pull-up structure in the master driver, and while the output of the slave presents a high impedance to the bus. On the next clock pulse 1526, the master device may begin a new transmission on the serial bus.

The mode of operation of the line driver in the slave device that is coupled to SDA 1502 is illustrated in the second timeline 1524. The line driver of the slave device is initially in an active mode 1532. When the slave device recognizes that the last bit 1506 of the data byte 1530 causes SDA 1502 to go to a LOW state, the slave device may cause its driver to enter high impedance mode 1520 to permit the master driver the option of takes control of SDA 1502. SDA 1502 may be pulled high by a termination resistor when the slave device enters high impedance mode 1520, and before the master device enters an active driving mode 1512.

In one example, the master device enters the open-drain mode 1518 (with pull-up) after, or while transmitting a falling edge of SCL 1504. The master device may extend the duration of the voltage high state on SCL 1504 to comply with timing requirements associated with open-drain mode 1518. After a sufficient delay, which is enabled by the extended pulse 1510, the master device pulls SDA 1502 low, thereby providing a repeated START condition (repeated START condition 1508). The master device keeps the SDA wire 1502 in the low state for a period of time sufficient to comply with timing requirements associated with open-drain mode 1518. After the falling edge of the pulse 1510, the master device may drive SDA 1502 in accordance with the next data bit that needs to be transmitted. The master device may then provide a rising edge of the next clock pulse on SCL 1504.

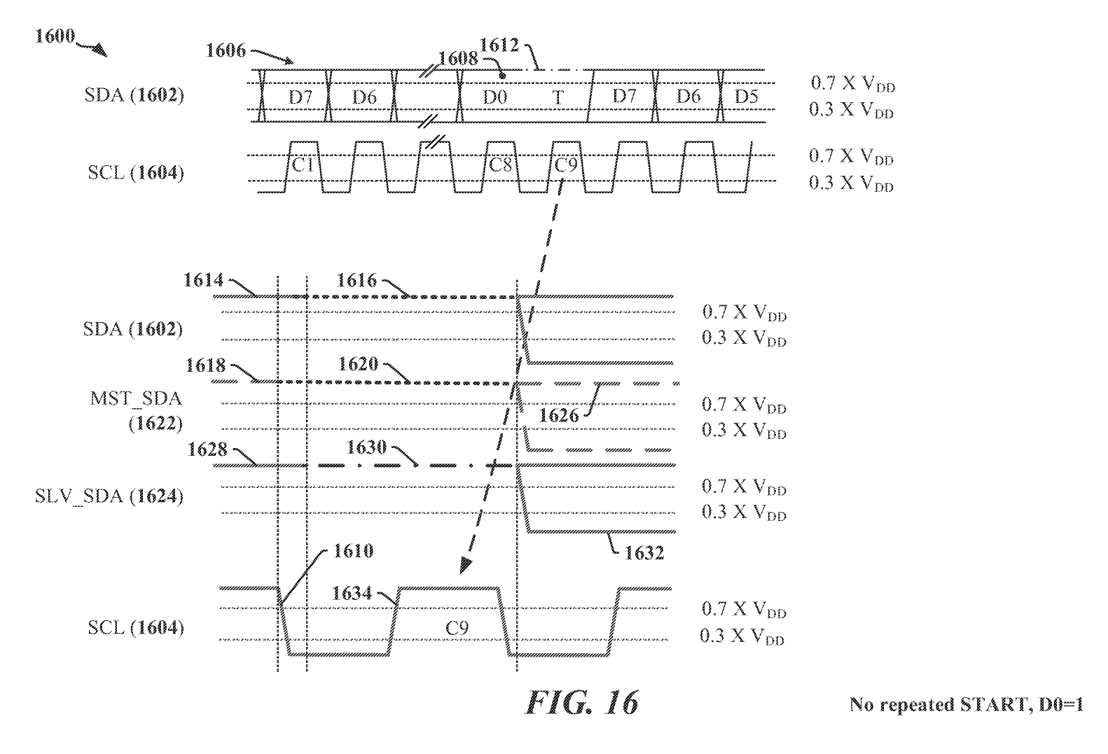

FIG. 16 includes timing diagrams 1600 that illustrate a first example of an operation in which a master device forgoes an opportunity to transmit a repeated START condition. This example may relate to an instance when the last bit of a data byte places SDA 1602 in a high voltage state. The mode of operation of the line driver in the master device that is coupled to SDA 1602 is illustrated in the first timeline 1622. During transmission of a data byte 1606 by the slave device, the line driver in the master device is in a high-impedance mode 1618 and does not create any conflicts with the corresponding driver of the slave device. As the last bit 1608 of the data byte 1606 is being transmitted by the slave device, the master device recognizes that the SDA wire 1602 is in a high voltage state. The master driver may cause the line driver of the master device to enter an open-drain mode 1630 (maintaining the high voltage state 1616 on SDA 1602) upon detection of the high voltage state corresponding to the last bit 1608 of the data byte 1606. In this example, the master device forgoes the opportunity to terminate the transmission.

The mode of operation of the line driver in the slave device that is coupled to SDA 1602 is illustrated in the second timeline 1624. The line driver of the slave device is initially in an active mode 1628 and actively drives 1614 SDA 1602. When the slave device recognizes that the last bit 1608 of the data byte 1606 has placed SDA 1602 in a high state, the slave device may cause its driver to enter high impedance mode 1620 to permit the master driver the option of takes control of SDA 1602. SDA 1602 may be pulled high by a termination resistor when the slave device enters high impedance mode 1620, and before the master device enters the high-impedance mode 1626. The master device forgoes the opportunity to terminate the transmission and the slave device may resume actively driving data 1632 on SDA 1602.

In one example, the master device enters open-drain mode (with open-drain class pull-up) after, or while initiating a falling edge 1610 of SCL 1604. After a delay that includes a clock-to-data turnaround time specified by protocol and a master-to-slave time of flight (e.g., signaling delay between master and slave), the slave device releases SDA 1602 and enters a high-impedance output mode. SDA 1602 remains in the high voltage state 1616 due to the action of the open-drain class pull-up. The master device disables the open-drain class pull-up after a short time after SCL 1604 enters a low voltage state. The slave device starts driving SDA 1602 in push-pull mode after its clock-to-data turnaround time. The slave device may drive SDA 1602 while the open-drain class pull-up is still enabled. The read transaction continues with transmission of data 1632 in push-pull mode.

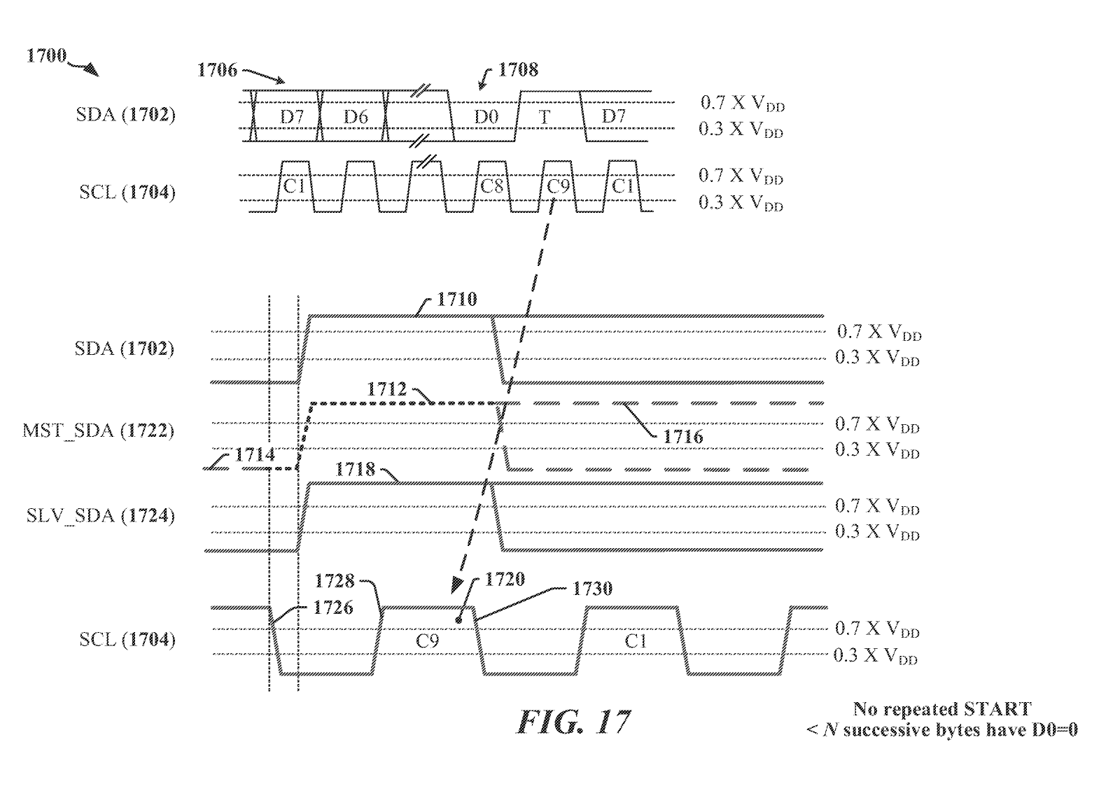

FIG. 17 includes timing diagrams 1700 that illustrate a second example of an operation in which a master device forgoes an opportunity to transmit a repeated START condition. The mode of operation of the line driver in the master device that is coupled to SDA 1702 is illustrated in the first timeline 1722. During transmission of a data byte 1706 by the slave device, the line driver in the master device is in a high-impedance mode 1714 and does not create any conflicts with the corresponding driver of the slave device. As the last bit 1708 of the data byte 1706 is being transmitted by the slave device, the master device recognizes that the SDA wire 1702 is in a low voltage state. The slave device continues driving the last bit 1708 in compliance with timing specifications for the bus, and in order to permit the last bit 1708 to be sampled at a receiver. In conventional systems, the master device has no opportunity to drive SDA 1702 in order to transmit a repeated start condition.

The slave device may be adapted according to certain aspects disclosed herein to release SDA 1702 after transmitting a last bit 1708 of the Nth byte that places SDA 1702 in a low voltage state. The value of N may be selected based on application, type of data transferred over the serial bus and other factors. The value of N may be selected based on a compromise between overhead introduced by increasing clock periods at the end of every Nth byte and latency, where the latency relates to the time elapsed before the slave transmission can be stopped. The value of N determines worst case latency.

In the example depicted in FIG. 17, the data byte 1706 is not the Nth sequentially-transmitted byte with a last bit 1708 of the Nth byte that places SDA 1702 in a low voltage state. In this example, the slave continues to drive SDA 1702. The master device may optionally enter an open-drain mode 1712 (with open-drain class pull-up). In some examples, the master device recognizes that the data byte 1706 is not the Nth sequentially-transmitted byte with a last bit 1708 of the Nth byte that places SDA 1702 in a low voltage state, and the master device remains in high-impedance mode 1714. In this example, the master device refrains from transmitting a repeated start condition.

The mode of operation of the line driver in the slave device that is coupled to SDA 1702 is illustrated in the second timeline 1724. The line driver of the slave device is initially in an active mode 1718. When the slave device recognizes that the data byte 1706 is not the Nth sequentially-transmitted byte with a last bit 1708 of the Nth byte that places SDA 1702 in a low voltage state, the slave device may continue driving SDA 1702.

In one example, the master device enters the open-drain mode 1712 (with open-drain class pull-up) after, or while transmitting a falling edge 1726 on SCL 1704. The master device may enable the open-drain class pull-up. After a delay that includes a clock-to-data turnaround time specified by protocol and a master-to-slave time of flight (e.g., signaling delay between master and slave), the slave device starts driving SDA 1702 to a high voltage state. The slave device may be designed to avoid timing issues. For example, certain characteristics of the slave device may be selected to avoid a delay that approaches 31 ns, at which point the Slave can miss the rising edge 1728 of the next pulse 1720 on SCL 1704. On the falling edge 1730 of the pulse 1720, the master device may disable the open-drain class pull-up. In some instances, the master device may disable the open-drain class pull-up at some time after the falling edge 1730 of the pulse 1720. The slave may then continue transmitting data in the READ transaction.

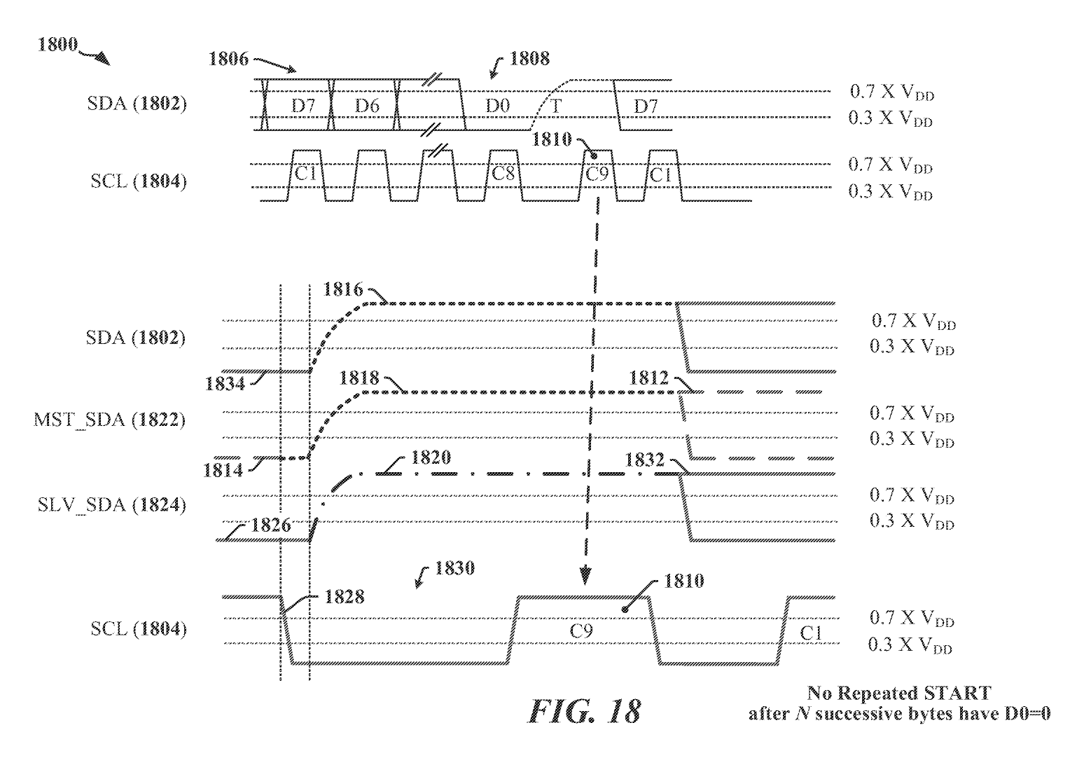

FIG. 18 includes timing diagrams 1800 that illustrate a third example of an operation in which a master device forgoes an opportunity to transmit a repeated START condition. The mode of operation of the line driver in the master device that is coupled to SDA 1802 is illustrated in a first timeline 1822 and the mode of operation of the line driver in the slave device that is coupled to SDA 1802 is illustrated in the second timeline 1824. During transmission of a data byte 1806 by the slave device, the line driver in the master device is in a high-impedance mode 1814 and does not create any conflicts with the corresponding driver of the slave device. The slave device is initially in an active mode 1826 and drives SDA 1802. As the last bit 1808 of the data byte 1806 is being transmitted by the slave device, the master device recognizes that the SDA wire 1802 is in a low voltage state 1834. The slave device continues driving the last bit 1808 in compliance with timing specifications for the bus, and to permit the last bit 1808 to be sampled at a receiver. In conventional systems, the master device has no opportunity to drive a repeated start condition on SDA 1802.

The slave device may be adapted according to certain aspects disclosed herein to release SDA 1802 after transmitting a last bit 1808 of the Nth byte that places SDA 1802 in a low voltage state. The value of N may be selected based on application, type of data transferred over the serial bus and other factors. The value of N may be selected based on a compromise between overhead introduced by increasing clock periods at the end of every Nth byte and latency, where the latency relates to the time elapsed before the slave transmission can be stopped. The value of N determines worst case latency and can be any integer value.

In the example depicted in FIG. 18, the data byte 1806 is the Nth sequentially-transmitted byte with a last bit 1808 that places SDA 1802 in a low voltage state. The slave device may be adapted to release SDA 1802 after transmitting the last bit 1808 of the Nth data byte 1806. In this example, the slave is in a high-impedance mode 1820 and presents a high-impedance to SDA 1802 providing the master device with the opportunity to transmit a repeated start condition. SDA 1802 may be pulled high by a terminating resistance. In one example, the master device may enter an open-drain mode 1818 with open-drain class pull-up that pulls SDA 1802 to a high voltage state 1816. The master device recognizes that the data byte 1806 is the Nth sequentially-transmitted byte with a last bit 1808 of the Nth byte that places SDA 1802 in a low voltage state and determines whether a repeated start is requested by the slave device. In this example, the master device refrains from transmitting a repeated start condition and the master device remains in open-drain mode 1818, or in high-impedance mode 1814 in some examples.

In the illustrated example, the master device enters the open-drain mode 1818 after, or while transmitting a falling edge 1828 on SCL 1804. The master device may enable the open-drain class pull-up while entering the open-drain mode 1818. The clock signal transmitted on SCL 1804 may be configured for open-drain timing to allow for slower transitions. For example, the low period 1830 before the C9 clock pulse 1810 may be prolonged when the clock signal is configured for open-drain timing. After a delay that includes a clock-to-data turnaround time specified by protocol and a master-to-slave time of flight (e.g., signaling delay between master and slave), the slave device releases SDA 1802 and enters high-impedance mode 1820. SDA 1802 may be pulled up by the open-drain class pull-up structure when the output of the slave device is in high-impedance mode 1820. SDA 1802 rises to the high voltage level. The master device records the high voltage state on SDA 1802 while SCL 1804 is stable at high voltage level during the C9 clock pulse 1810. The master device consequently assesses that the slave device accepts the continuation of the READ transaction. The master device may then disable the open-drain class pull-up as it starts the falling edge of the C9 clock pulse 1810 on SCL 1804. In some instances, the master device may disable the open-drain class pull-up after the falling edge of the C9 clock pulse 1810 has been started on SCL 1804. The slave device may enable its push-pull output 1832 and begin driving SDA 1802, after its clock-to-data turnaround time specified by protocol. It can be appreciated that the slave device may drive SDA 1802 low while open-drain class pull-up is enabled. The READ transaction continues in push-pull mode.

Accelerated I3C Stop Initiated by a Transaction Outsider

According to certain aspects disclosed herein, an I3C STOP condition may be triggered during a transaction by a device that is not a party to the transaction. A device that is not a party to the transaction may be referred to herein as an outsider device. In one example, an outsider device with high priority data to transmit may force an I3C STOP condition during a transaction between two insider devices coupled to an I3C bus. The insider devices typically include a master device and a slave device. In one example, the insider devices may be adapted to support an accelerated stop while the master device is reading from the slave device (see FIGS. 12-14). In another example, the master device may be adapted to support an accelerated stop while the master device is writing to the slave device, such that an outsider device may drive a repeated start condition on the I3C bus. The master device may be further adapted to initiate an arbitration process when an accelerated stop is initiated by the master device or by an outsider device.

The early termination of data transfer can enable complex systems to cope with urgent situations. In various examples, a lack of memory resources, the imminent need for a change of mode, or initiation of a different action by the receiver or an outsider device. Such events or requirements may arise when a large data transfer is in progress. For example, the receiver may not have enough memory available at the time of the transaction. In another example, the I3C bus may not be available to a camera application that defines precise moments in time when some action needs to be taken. In other examples, outsider devices may need urgent access to an I3C bus when the bus is involved in a transaction between other devices. An outsider device may seek priority access to the I3C in emergency situations, such as when overheating is detected, when devices monitoring a transaction and collecting data are running out of resources, or in critical low-latency applications such as Touch Display applications.

Devices coupled to the I3C bus may be adapted to intervene as outsiders in an ongoing transaction in accordance with certain aspects disclosed herein. The I3C bus may couple some devices that are capable of intervening in the course of a transaction to which they are not a direct party, while other devices may be incapable of such intervention. A bus master or other device may maintain information identifying device capabilities and configurations, including the capability to intervene as an outsider device in a transaction. In some implementations, intervention capability may be enabled or disabled for individual devices and/or for all devices coupled to an I3C bus. Intervention capabilities may be configured by an application. Typically, a primary bus master device controls configuration and/or assignment of intervention capability, while secondary bus masters are promptly informed of the device configurations and/or capabilities.

In some aspects, intervention capabilities may be enabled and/or disabled using a

Common Command Code (CCC), which may be a broadcast CCC or a direct CCC. A broadcast CCC may be transmitted to control, configure, enable and/or disable all devices capable of intervention as outsiders. The broadcast CCC may include a code identifying the intervention capability as the target of the CCC, with data that defines the state (e.g. enabled or disabled) of the intervention function on all devices capable of intervention as outsiders. A direct CCC may be directed to a specific address, which may be a device address or a group address recognized by two or more devices. The direct CCC may include a code identifying the intervention capability as the target of the CCC, with data that defines the state (e.g. enabled or disabled) of the intervention function on all devices capable of intervention as outsiders.

In one example, a device capable of intervention as an outsider may request the current bus master to enable its intervention feature by assert an I3C In-Band Interrupt (IBI) with a mandatory data byte (MDB) set to the value of the direct CCC used for enabling outsider intervention capabilities. Upon receiving the IBI, the current bus master may transmit the requested direct CCC, enabling the outsider intervention function. In some instances, the bus master device may refrain from enabling the intervention feature.

According to certain aspects, an outsider device may intervene in a read transaction as disclosed herein, including in the manner illustrated by FIGS. 12-14, where the outsider device drives the I3C bus when the insider devices have entered high-impedance and/or open-drain modes. When one or more enabled outsider devices are coupled to the I3C bus, an outsider device may request early termination of a READ transaction ending by intervening in the flow in the manner that an insider receiving device can intervene in the transaction.

The current bus master may transmit a STOP condition when the intervention of an outsider device is detected. For example, the current bus master may be adapted to reassert control of the I3C bus by transmitting repeated START condition followed by a STOP condition after recognizing that an outsider device has driven the I3C bus when the insider devices are in high-impedance mode between bytes of the transaction. When early termination is requested by an insider device, the current bus master has the option of continuing data transfer or initiate data transfer with another device after transmitting the repeated START condition. In some instances, an outsider device may request early termination of a READ transaction at the same time that the current bus master has requested early termination of the READ transaction, and the current bus master may enter a bus arbitration process to determine a next transaction.

In some implementations, the current bus master may immediately start a new transaction using the I3C Broadcast Address (7′h7E). When the current bus master requested the early termination, the current bus master may assess whether it was the only requester of early termination and may proceed with whatever action prompted the early termination request. The current bus master may determine that a known and enabled outsider device is contending for the I3C bus and the current bus master may service the IBI requested by the outsider device, or continue with its own course of action, as per the application level priority ranking When several outsiders are contending for the I3C bus, the current bus master may repeat the arbitration process by, for example, transmitting a START condition followed by the I3C Broadcast Address until all contending devices are serviced. The current bus master may determine that an unknown or disabled enabled outsider device is contending for the I3C bus and the current bus master may disable IBI requests from such Device before continuing the arbitration process.

When the current bus master has not requested the early termination, the current bus master may determine that a known and enabled outsider device is contending for the I3C bus and the current bus master may service the IBI requested by the outsider device, or continue with its own course of action, as per the application level priority ranking When several outsiders are contending for the I3C bus, the current bus master may repeat the arbitration process by, for example, transmitting a START condition followed by the I3C Broadcast Address until all contending devices are serviced. The current bus master may determine that an unknown or disabled enabled outsider device is contending for the I3C bus and the current bus master may disable IBI requests from such Device before continuing the arbitration process.

When the current bus master has not requested the early termination, the current bus master and there is no contention for the I3C bus, the current bus master may assess that the requesting outsider device is in an error state or busy with another task. The current bus master may take any appropriate or configured action, which may include transmitting a STOP condition to reset the state of the I3C interface in the intervening outsider device.

In some instances, the current master device may have initiated an early termination, and may execute the contention process to determine if another device has concurrently intervened to initiate early termination. For example, the current master device may have one or more transactions pending that include high priority data, and the current master may initiate termination of a transaction in process at or near the time that a slave device, which is not party to the transaction, also initiates early termination. The current master device may participate in a contention procedure it initiates after early termination.

According to certain aspects, an outsider device may intervene in a write transaction, where the outsider device drives the I3C bus when the insider devices have entered high-impedance and/or open-drain modes.

The current bus master transmits a STOP condition when the intervention of an outsider device is detected. For example, the current bus master may be adapted to reassert control of the I3C bus by transmitting repeated START condition followed by a STOP condition. The current bus master may be unable to determine whether early termination was requested by an insider device, an outsider device and/or multiple devices. The current bus master may enter a bus arbitration process to determine a next transaction.

In some implementations, the current bus master may immediately start a new transaction using the I3C Broadcast Address (7′h7E). When the current bus master requested the early termination, the current bus master may assess whether it was the only requester of early termination and may proceed with whatever action prompted the early termination request. The current bus master may determine that a known and enabled outsider device is contending for the I3C bus and the current bus master may service the IBI requested by the outsider device, or continue with its own course of action, as per the application level priority ranking When several outsiders are contending for the I3C bus, the current bus master may repeat the arbitration process by, for example, transmitting a START condition followed by the I3C Broadcast Address until all contending devices are serviced. The current bus master may determine that an unknown or disabled enabled outsider device is contending for the I3C bus and the current bus master may disable IBI requests from such Device before continuing the arbitration process.

When the current bus master has not requested the early termination, the current bus master may determine that a known and enabled outsider device is contending for the I3C bus and the current bus master may service the IBI requested by the outsider device, or continue with its own course of action, as per the application level priority ranking When several outsiders are contending for the I3C bus, the current bus master may repeat the arbitration process by, for example, transmitting a START condition followed by the I3C Broadcast Address until all contending devices are serviced. The current bus master may determine that an unknown or disabled enabled outsider device is contending for the I3C bus and the current bus master may disable IBI requests from such Device before continuing the arbitration process.

When the current bus master has not requested the early termination, the current bus master and there is no contention for the I3C bus, the current bus master may assess that the requesting outsider device is in an error state or busy with another task. The current bus master may take any appropriate or configured action, which may include transmitting a STOP condition to reset the state of the I3C interface in the intervening outsider device.

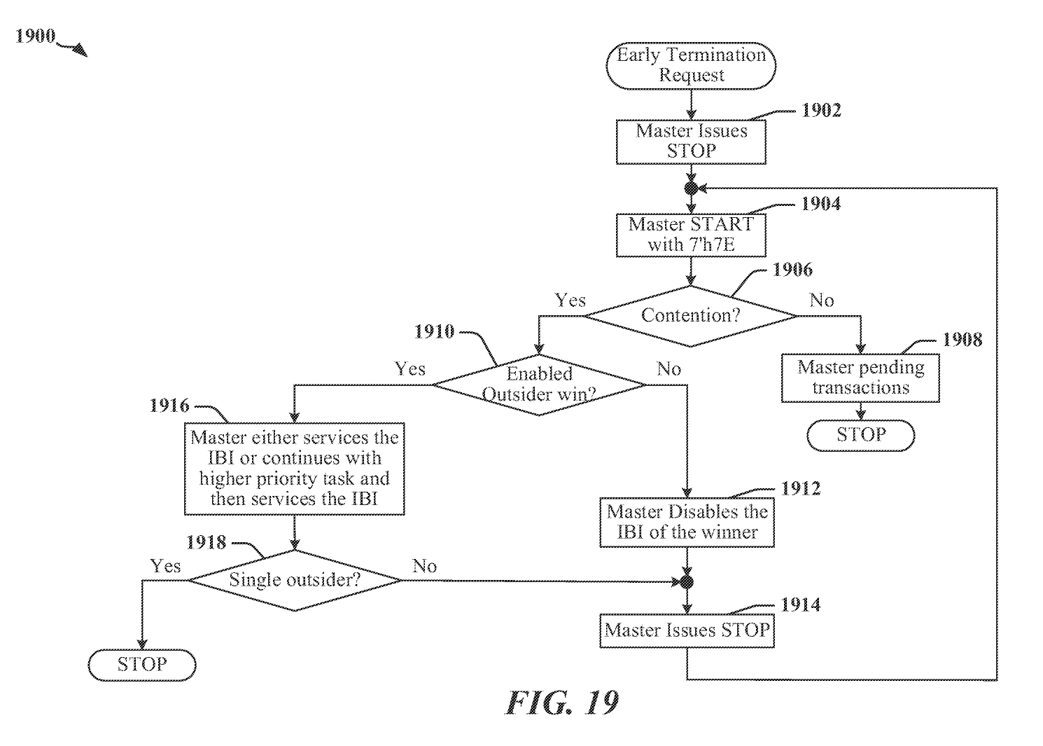

FIG. 19 illustrates an example of a contention resolution process that may be executed by a master device adapted in accordance with certain aspects disclosed herein. The process may be initiated after an early termination request by an insider device and/or one or more outsider devices. In one example, early termination may be requested by driving one or more wires of an I3C bus when insider devices are in high-impedance and/or open-collector modes, as disclosed in certain examples provided herein. In some instances, the early termination may be requested by transmitting a repeated START condition on the I3C bus. In one example, a current master device may request early termination by transmitting the repeated START condition. In another example, the current master device may transmit a repeated START condition after detecting that one or more wires of the I3C bus have been driven when insider devices are in high-impedance and/or open-collector modes. Other techniques for triggering early termination may be employed.

At block 1902, the current master device may transmit a STOP condition. The STOP condition may follow a repeated START condition, but can also be transmitted as part of handling of the early termination request. The STOP condition is expected to unambiguously terminates any transaction in progress on the bus and may effect reset of bus interface circuits in devices coupled to the I3C bus.

At block 1904, the current master device may initiate a new transaction using a broadcast command directed to the I3C Broadcast Address (7′h7E). The current bus master may the determine whether one or more slave devices have requested early termination. In some instances, the current master device may have initiated a request for early termination. The current master device may be the sole requester of early termination or may be one of a plurality of devices that attempted to initiate the early termination request.

At block 1906, the current master device may determine if any slave devices have responded to the broadcast command as a means to contend for access to the I3C bus. If no slave devices have responded, the current master device may proceed at block 1908. If one or more slave devices have responded, the current master device may proceed at block 1910.

At block 1908, the current master device has determined that no slave devices have responded to the broadcast command The broadcast command may be one of multiple broadcast commands used to identify and service slave devices, and block 1908 may be reached after all slave devices have been serviced. The current master device may then execute one or more pending transactions, including when a pending transaction caused the current master device to initiate the early termination of a previous transaction. The current master device may transmit a STOP condition when no pending transactions remain. In some example, the current master device may execute a pending transaction before terminating the contention cycle.

At block 1910, the current master device has determined that no slave devices have responded to the broadcast command The current master device may select a highest priority contender for access to the I3C bus and/or may select one of the contenders to access the I3C bus based on other criteria or a system configuration. The current master device may determine if the selected contender is an enabled outsider device. An outsider device is adapted to intervene in transactions between other devices when enabled. The outsider device can be enabled or disabled by initial configuration or during operation by a master device. The outsider device may be enabled or disabled at the direction of an application. The current master device may maintain configuration information identifying whether a slave device has been adapted or configured to operate as an outsider device and the enablement status of outsider devices. When the current master device determines that the selected contender is not an enabled outsider device, current master device may proceed to block 1912. The current master device may proceed to block 1914 when the selected contender is an enabled outsider device.

At block 1912, the current master device has selected a slave device for service that is not an enabled outsider device. The current master device may transmit a configuration command or otherwise prevent the selected contender from participating further in the contention process. In one example, the current master device may transmit a configuration command that causes the selected contender to disable its in-band interrupt (IBI) capability when IBIs are used in the contention process. In another example, the current master device may mask IBIs received from the selected contender such that the selected contender is ignored in further contention cycles.

At block 1914, the current master device may transmit a STOP command to terminate the current cycle of the contention resolution process. The current master device may return to block 1904 to perform the next cycle of the contention resolution process.

At block 1916, the current master device may have identified the selected contender as an enabled outsider. The current master device may service the selected contender or may initiate a pending transaction that is of higher priority than the servicing of the selected contender. When the current master device chooses one of its pending transaction for servicing the selected contender remains in contention during a next cycle of the contention resolution process.

At block 1918, the current master device may recognize from the current contention cycle that no further contenders remain. When no further contenders remain, and the current master device has no pending transactions, the contention resolution process may be terminated. Otherwise, the current master device may continue the contention resolution process at block 1914.

Examples of Processing Circuits and Methods

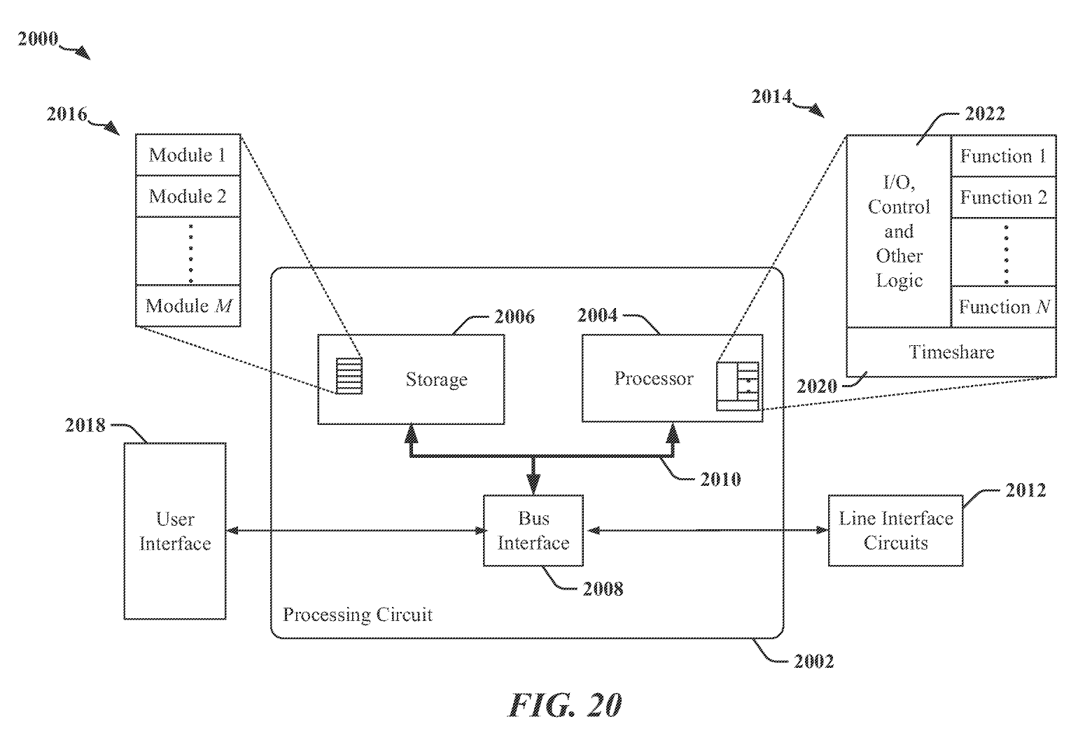

FIG. 20 is a diagram illustrating an example of a hardware implementation for an apparatus 2000 employing a processing circuit 2002 that may be configured to perform one or more functions disclosed herein. In accordance with various aspects of the disclosure, an element, or any portion of an element, or any combination of elements as disclosed herein may be implemented using the processing circuit 2002. The processing circuit 2002 may include one or more processors 2004 that are controlled by some combination of hardware and software modules. Examples of processors 2004 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 2004 may include specialized processors that perform specific functions, and that may be configured, augmented or controlled by one of the software modules 2016. The one or more processors 2004 may be configured through a combination of software modules 2016 loaded during initialization, and further configured by loading or unloading one or more software modules 2016 during operation.

In the illustrated example, the processing circuit 2002 may be implemented with a bus architecture, represented generally by the bus 2010. The bus 2010 may include any number of interconnecting buses and bridges depending on the specific application of the processing circuit 2002 and the overall design constraints. The bus 2010 links together various circuits including the one or more processors 2004, and storage 2006. Storage 2006 may include memory devices and mass storage devices, and may be referred to herein as computer-readable media and/or processor-readable media. The bus 2010 may also link various other circuits such as timing sources, timers, peripherals, voltage regulators, and power management circuits. A bus interface 2008 may provide an interface between the bus 2010 and one or more transceivers 2012. A transceiver 2012 may be provided for each networking technology supported by the processing circuit. In some instances, multiple networking technologies may share some or all of the circuitry or processing modules found in a transceiver 2012. Each transceiver 2012 provides a means for communicating with various other apparatus over a transmission medium. Depending upon the nature of the apparatus 2000, a user interface 2018 (e.g., keypad, display, speaker, microphone, joystick) may also be provided, and may be communicatively coupled to the bus 2010 directly or through the bus interface 2008.

A processor 2004 may be responsible for managing the bus 2010 and for general processing that may include the execution of software stored in a computer-readable medium that may include the storage 2006. In this respect, the processing circuit 2002, including the processor 2004, may be used to implement any of the methods, functions and techniques disclosed herein. The storage 2006 may be used for storing data that is manipulated by the processor 2004 when executing software, and the software may be configured to implement any one of the methods disclosed herein.

One or more processors 2004 in the processing circuit 2002 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 2006 or in an external computer-readable medium. The external computer-readable medium and/or storage 2006 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 2006 may also include, by way of example, a carrier wave, a transmission line, and any other suitable medium for transmitting software and/or instructions that may be accessed and read by a computer. Computer-readable medium and/or the storage 2006 may reside in the processing circuit 2002, in the processor 2004, external to the processing circuit 2002, or be distributed across multiple entities including the processing circuit 2002. The computer-readable medium and/or storage 2006 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 2006 may maintain software maintained and/or organized in loadable code segments, modules, applications, programs, etc., which may be referred to herein as software modules 2016. Each of the software modules 2016 may include instructions and data that, when installed or loaded on the processing circuit 2002 and executed by the one or more processors 2004, contribute to a run-time image 2014 that controls the operation of the one or more processors 2004. When executed, certain instructions may cause the processing circuit 2002 to perform functions in accordance with certain methods, algorithms and processes described herein.

Some of the software modules 2016 may be loaded during initialization of the processing circuit 2002, and these software modules 2016 may configure the processing circuit 2002 to enable performance of the various functions disclosed herein. For example, some software modules 2016 may configure internal devices and/or logic circuits 2022 of the processor 2004, and may manage access to external devices such as the transceiver 2012, the bus interface 2008, the user interface 2018, timers, mathematical coprocessors, and so on. The software modules 2016 may include a control program and/or an operating system that interacts with interrupt handlers and device drivers, and that controls access to various resources provided by the processing circuit 2002. The resources may include memory, processing time, access to the transceiver 2012, the user interface 2018, and so on.

One or more processors 2004 of the processing circuit 2002 may be multifunctional, whereby some of the software modules 2016 are loaded and configured to perform different functions or different instances of the same function. The one or more processors 2004 may additionally be adapted to manage background tasks initiated in response to inputs from the user interface 2018, the transceiver 2012, and device drivers, for example. To support the performance of multiple functions, the one or more processors 2004 may be configured to provide a multitasking environment, whereby each of a plurality of functions is implemented as a set of tasks serviced by the one or more processors 2004 as needed or desired. In one example, the multitasking environment may be implemented using a timesharing program 2020 that passes control of a processor 2004 between different tasks, whereby each task returns control of the one or more processors 2004 to the timesharing program 2020 upon completion of any outstanding operations and/or in response to an input such as an interrupt. When a task has control of the one or more processors 2004, the processing circuit is effectively specialized for the purposes addressed by the function associated with the controlling task. The timesharing program 2020 may include an operating system, a main loop that transfers control on a round-robin basis, a function that allocates control of the one or more processors 2004 in accordance with a prioritization of the functions, and/or an interrupt driven main loop that responds to external events by providing control of the one or more processors 2004 to a handling function.

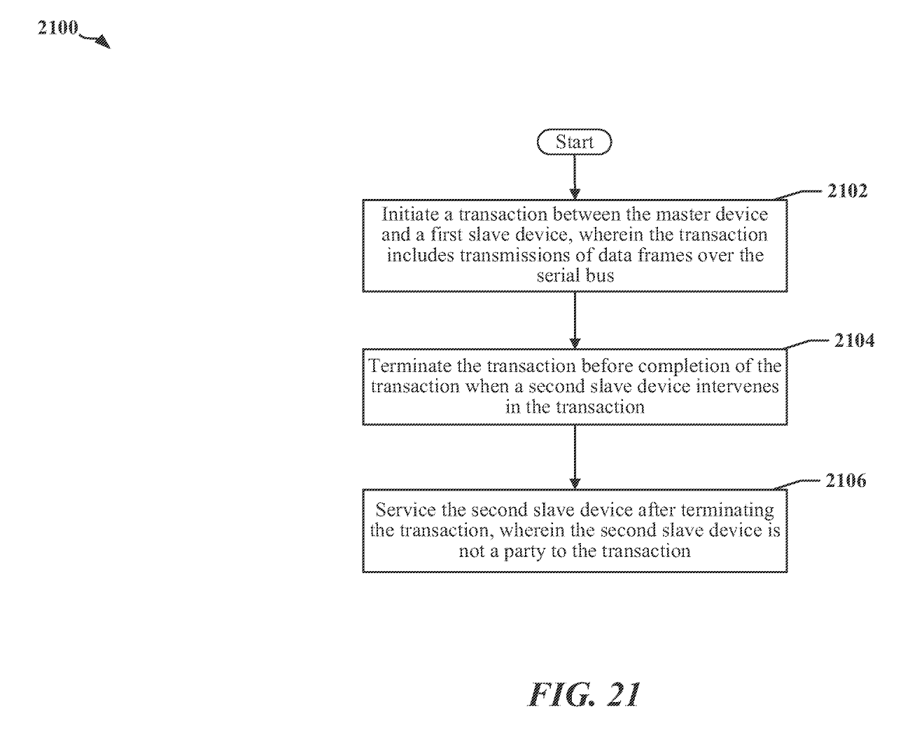

FIG. 21 is a flowchart 2100 of a method that may be performed at a master device coupled to a serial bus and configured to communicate in accordance with one or more protocols, including an I3C protocol.

At block 2102, the master device may initiate a transaction between the master device and a first slave device. The transaction may include transmissions of data frames over the serial bus.

At block 2104, the master device may terminate the transaction before completion of the transaction when a second slave device intervenes in the transaction. The second slave device may intervene in the transaction by transmitting in-band signaling on the serial bus while the transaction is being executed. The in-band signaling may include driving one or more wires of the serial bus when interface circuits of the master device and the first slave device are in a high-impedance mode of operation or an open-collector mode of operation between data frames of the transaction. Terminating the transaction before completion of the transaction may include transmitting a STOP condition on the serial bus. Terminating the transaction before completion of the transaction may include transmitting a repeated START condition followed by a STOP condition on the serial bus. Terminating the transaction before completion of the transaction may include continuing the in-band signaling to provide a repeated START condition on the serial bus, and transmitting a STOP condition on the serial bus.

At block 2106, the master device may service the second slave device after terminating the transaction. The second slave device may not be a party to the transaction.

The method may include transmitting a broadcast command on the serial bus, the broadcast command being configured to cause one or more slave devices to contend for access to the serial bus, and servicing the second slave device when the second slave device is identified as having highest priority of the one or more slave devices that are contending for access to the serial bus. The one or more slave devices may contend for access to the serial bus using in-band interrupts. The second slave device may be serviced when the second slave device is identified as having higher priority than one or more pending transactions to be executed by the master device. In some examples, the master device may request termination of the transaction concurrently with an intervention by the second slave device in the transaction. The first device may be one of a plurality of slave devices concurrently contending for access to the serial bus. The master device may determine whether the second slave device is enabled to intervene in the transaction, and may service the second slave device when the second slave device is enabled to intervene in the transaction.

The master device may identify a third slave device having higher priority data than data on the second slave device, determine that the second slave device is not enabled to intervene in the transaction, and service the second slave device when the second slave device is enabled to intervene in the transaction. In some examples, the master device may transmit one or more configuration commands to the second slave device, where the configuration commands are configured to enable and/or disable the ability of the second slave device to intervene as an outsider in a transaction conducted on the serial bus.

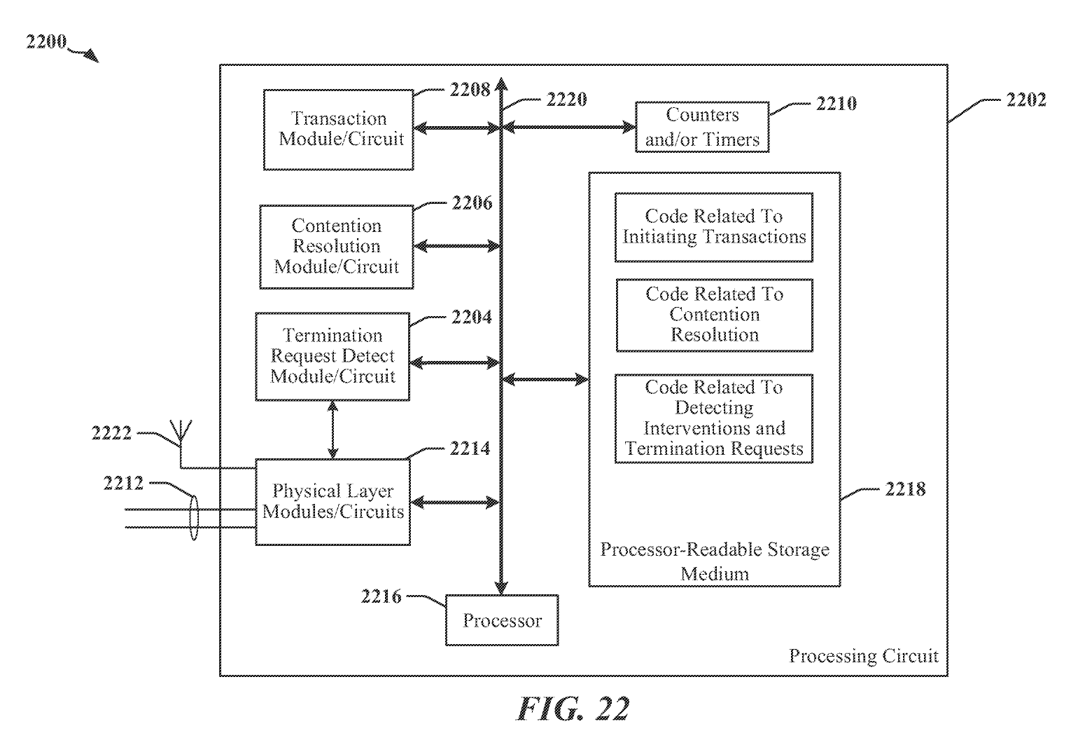

FIG. 22 is a diagram illustrating a simplified example of a hardware implementation for an apparatus 2200 employing a processing circuit 2202. The apparatus may implement, or be implemented in a slave device in accordance with certain aspects disclosed herein. The processing circuit typically has a controller or processor 2216 that may include one or more microprocessors, microcontrollers, digital signal processors, sequencers and/or state machines. The processing circuit 2202 may be implemented with a bus architecture, represented generally by the bus 2220. The bus 2220 may include any number of interconnecting buses and bridges depending on the specific application of the processing circuit 2202 and the overall design constraints. The bus 2220 links together various circuits including one or more processors and/or hardware modules, represented by the controller or processor 2216, the modules or circuits 2204, 2206 and 2208, and the processor-readable storage medium 2218. One or more physical layer circuits and/or modules 2214 may be provided to support communications over a communication link implemented using a multi-wire bus 2212, through an antenna 2222 (to a radio network for example), and so on. The bus 2220 may also link various other circuits such as timing sources 2210, peripherals, voltage regulators, and power management circuits, which are well known in the art, and therefore, will not be described any further.

The processor 2216 is responsible for general processing, including the execution of software, code and/or instructions stored on the processor-readable storage medium 2218. The processor-readable storage medium may include a non-transitory storage medium. The software, when executed by the processor 2216, causes the processing circuit 2202 to perform the various functions described supra for any particular apparatus. The processor-readable storage medium may be used for storing data that is manipulated by the processor 2216 when executing software. The processing circuit 2202 further includes at least one of the modules 2204, 2206 and 2208. The modules 2204, 2206 and 2208 may be software modules running in the processor 2216, resident/stored in the processor-readable storage medium 2218, one or more hardware modules coupled to the processor 2216, or some combination thereof. The modules 2204, 2206 and 2208 may include microcontroller instructions, state machine configuration parameters, or some combination thereof.

In one configuration, the apparatus 2200 includes a module and/or circuit 2204 configured to detect a request for early termination, which may be indicated by an intervention into a transaction by an outsider device, modules and/or circuits 2208, 2214 configured to manage data transactions over a multi-wire bus 2212, and modules and/or circuits 2206 configured to manage contention resolution when multiple devices seek access to the multi-wire bus 2212.

In one example, the apparatus 2200 may be adapted to operate as a master device when coupled to a serial bus. The apparatus 2200 may include a bus interface circuit, and a processing device. The processing device may be adapted to initiate a transaction between the master device and a first slave device. The transaction may include transmissions of data frames over the serial bus. The processing device may be adapted to terminate the transaction before completion of the transaction when a second slave device intervenes in the transaction, and service the second slave device after terminating the transaction. The second slave device can be a device that is not a party to the transaction.

The processing device may be adapted to transmit a broadcast command on the serial bus, the broadcast command being configured to cause one or more slave devices to contend for access to the serial bus, and service the second slave device when the second slave device is identified as having highest priority of the one or more slave devices that are contending for access to the serial bus. The one or more slave devices may contend for access to the serial bus using in-band interrupts. The second slave device may be serviced when the second slave device is identified as having higher priority than one or more pending transactions to be executed by the master device. The second slave device may request termination of the transaction concurrently with an intervention by the second slave device in the transaction. The first device may be one of a plurality of slave devices concurrently contending for access to the serial bus. The apparatus 2200 may determine whether the second slave device is enabled to intervene in the transaction, and may service the second slave device when the second slave device is enabled to intervene in the transaction. The apparatus 2200 may identify a third slave device having higher priority data than data on the second slave device, determine that the second slave device is not enabled to intervene in the transaction, and service the second slave device when the second slave device is enabled to intervene in the transaction.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method performed at a master device coupled to a serial bus, comprising:
initiating a transaction between the master device and a first slave device, wherein the transaction includes transmissions of data frames over the serial bus;
terminating the transaction before completion of the transaction when a second slave device intervenes in the transaction; and
servicing the second slave device after terminating the transaction,
wherein the second slave device is not a party to the transaction.

2. The method of claim 1, wherein the second slave device is configured to intervene in the transaction by transmitting in-band signaling on the serial bus while the transaction is being executed.

3. The method of claim 1, further comprising:
determining that the second slave device has intervened in the transaction when one or more wires of the serial bus changes state while interface circuits of the master device and the first slave device are in a high-impedance mode of operation or an open-collector mode of operation between the data frames of the transaction.

4. The method of claim 3, wherein terminating the transaction before completion of the transaction comprises:
driving the one or more wires of the serial bus in their changed state to provide a repeated START condition on the serial bus; and
transmitting a STOP condition on the serial bus after providing the repeated START condition.

5. The method of claim 1, wherein terminating the transaction before completion of the transaction comprises:
transmitting a STOP condition on the serial bus.

6. The method of claim 1, wherein terminating the transaction before completion of the transaction comprises:
transmitting a repeated START condition followed by a STOP condition on the serial bus.

7. The method of claim 1, further comprising:
transmitting a broadcast command on the serial bus, the broadcast command being configured to cause one or more slave devices to contend for access to the serial bus; and
servicing the second slave device when the second slave device is identified as having highest priority of the one or more slave devices that are contending for access to the serial bus.

8. The method of claim 7, wherein the one or more slave devices contend for access to the serial bus using in-band interrupts.

9. The method of claim 7, wherein the second slave device is serviced when the second slave device is identified as having higher priority than one or more pending transactions to be executed by the master device.

10. The method of claim 9, further comprising:
requesting, by the master device, termination of the transaction concurrently with an intervention by the second slave device in the transaction.

11. The method of claim 7, wherein the first slave device is one of a plurality of slave devices concurrently contending for access to the serial bus.

12. The method of claim 7, further comprising:
determining whether the second slave device is enabled to intervene in the transaction; and
servicing the second slave device when the second slave device is enabled to intervene in the transaction.

13. The method of claim 7, further comprising:
identifying a third slave device having higher priority data than data on the second slave device;
determining that the second slave device is not enabled to intervene in the transaction; and
servicing the second slave device when the second slave device is enabled to intervene in the transaction.

14. The method of claim 7, further comprising:
transmitting a configuration command to the second slave device, the configuration command being configured to enable the second slave device to intervene as an outsider in the transaction between the master device and the first slave device.

15. An apparatus adapted to operate as a master device when coupled to a serial bus, the apparatus comprising:
a bus interface circuit; and
a processor configured to:
initiate a transaction between the master device and a first slave device, wherein the transaction includes transmissions of data frames over the serial bus;
terminate the transaction before completion of the transaction when a second slave device intervenes in the transaction; and
service the second slave device after terminating the transaction,
wherein the second slave device is not a party to the transaction.

16. The apparatus of claim 15, wherein the second slave device is configured to intervene in the transaction by transmitting in-band signaling on the serial bus while the transaction is being executed.

17. The apparatus of claim 15, wherein the processor is further configured to:
determine that the second slave device has intervened in the transaction when one or more wires of the serial bus changes state while the bus interface circuit is in a high-impedance mode of operation or an open-collector mode of operation between the data frames of the transaction.

18. The apparatus of claim 15, wherein the processor is further configured to:
transmit a broadcast command on the serial bus, the broadcast command being configured to cause one or more slave devices to contend for access to the serial bus; and
service the second slave device when the second slave device is identified as having highest priority of the one or more slave devices that are contending for access to the serial bus.

19. The apparatus of claim 18, wherein the one or more slave devices contend for access to the serial bus using in-band interrupts.

20. The apparatus of claim 18, wherein the second slave device is serviced when the second slave device is identified as having higher priority than one or more pending transactions to be executed by the master device.

21. The apparatus of claim 18, wherein the processor is further configured to:
transmit a configuration command to the second slave device, the configuration command being configured to enable the second slave device to intervene as an outsider in the transaction between the master device and the first slave device.

22. An apparatus, comprising:
means for initiating a transaction between the apparatus and a first slave device, wherein the transaction includes transmissions of data frames over a serial bus;
means for terminating the transaction before completion of the transaction when a second slave device intervenes in the transaction; and
means for servicing the second slave device after terminating the transaction, wherein the second slave device is not a party to the transaction.

23. The apparatus of claim 22, wherein the second slave device is configured to intervene in the transaction by transmitting in-band signaling on the serial bus while the transaction is being executed.

24. The apparatus of claim 22, wherein the means for terminating the transaction is configured to:
determine that the second slave device has intervened in the transaction when one or more wires of the serial bus changes state when interface circuits of the apparatus and the first slave device are in a high-impedance mode of operation or an open-collector mode of operation between the data frames of the transaction.

25. The apparatus of claim 22, wherein the means for servicing the second slave device is configured to:
transmit a broadcast command on the serial bus, the broadcast command being configured to cause one or more slave devices to contend for access to the serial bus; and
service the second slave device when the second slave device is identified as having highest priority of the one or more slave devices that are contending for access to the serial bus.

26. The apparatus of claim 25, wherein the one or more slave devices contend for access to the serial bus using in-band interrupts.

27. The apparatus of claim 25, wherein the second slave device is serviced when the second slave device is identified as having higher priority than one or more pending transactions to be executed by the apparatus.

28. A processor-readable storage medium having code stored thereon that, when executed by a processor, causes the processor to:
initiate a transaction between a master device and a first slave device, wherein the transaction includes transmissions of data frames over a serial bus;
terminate the transaction before completion of the transaction when a second slave device intervenes in the transaction; and
service the second slave device after terminating the transaction,
wherein the second slave device is not a party to the transaction.

29. The storage medium of claim 28, wherein the second slave device is configured to intervene in the transaction by transmitting in-band signaling on the serial bus while the transaction is being executed.

30. The storage medium of claim 28, wherein the code further causes the processor to:
determine that the second slave device has intervened in the transaction when one or more wires of the serial bus changes state when interface circuits of the master device and the first slave device are in a high-impedance mode of operation or an open-collector mode of operation between the data frames of the transaction.
